(19) United States
(12) Patent Application Publication
(10) Pub. No.: US 2025/0142432 A1
(43) Pub. Date: May 1, 2025

(54) CONFIGURATION ENHANCEMENTS FOR L1/L2 MOBILITY

(71) Applicant: Nokia Technologies Oy, Espoo (FI)

(72) Inventors: Amaanat ALI, Espoo (FI); Subramanya CHANDRASHEKAR, Bangalore (IN); Srinivasan SELVAGANAPATHY, Bangalore (IN); Tero HENTTONEN, Espoo (FI); Ahmad AWADA, Munich (DE)

(21) Appl. No.: 18/835,581

(22) PCT Filed: Jan. 13, 2023
(86) PCT No.: PCT/EP2023/050698

§ 371 Date: Aug. 2, 2024

(30) Foreign Application Priority Data
Feb. 10, 2022 (IN) 202241007115

(51) Int. Cl. H04W 36/08; H04W 36/00

(52) U.S. Cl. CPC H04W 36/08; H04W 36/0058; H04W 36/0061

(57) ABSTRACT

Techniques for performing efficient L1/L2 mobility are provided. For example, a method in a user equipment (UE) connected to a serving cell, is provided. The method comprises receiving, from a first network node, a first reconfiguration message including a first base configuration common to a plurality of first cells served by the first network node and a plurality of first cell-specific configurations each related to one of the plurality of first cells to enable execution of a mobility procedure; and applying, upon execution of the mobility procedure, at least a cell-specific configuration for a first target cell from among the plurality of first cell-specific configurations to connect the UE to the first target cell.

### FIELD

Various example embodiments described herein generally relate to wireless communication systems and more particularly, to wireless communication systems allowing configuration for L1/L2 mobility. Yet more particularly, some example embodiments provide methods and apparatuses for efficient configuration for L1/L2 mobility.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations, or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeter, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHz).

### SUMMARY

According to a first aspect of the subject disclosure, an apparatus comprises at least one processor; and at least one memory including computer program code. The at least one memory and the computer program code are configured to cause the apparatus at least to: receive, from a first network node by a user equipment (UE) connected to a serving cell, a first reconfiguration message including a first base configuration common to a plurality of first cells served by the first network node and a plurality of first cell-specific configurations each related to one of the plurality of first cells to enable execution of a mobility procedure; and apply, by the UE upon execution of the mobility procedure, at least a cell-specific configuration for a first target cell from among the plurality of first cell-specific configurations to connect the UE to the first target cell.

In some example embodiments, the computer program code may be further configured to cause the apparatus at least to: apply, by the UE upon execution of the mobility procedure, the first base configuration and the first cell-specific configuration for the first target cell in response to a base configuration applied for the serving cell being different to the first base configuration.

In some example embodiments, the computer program code may be further configured to cause the apparatus at least to: store, by the UE, the first base configuration and the plurality of first cell-specific configurations for the first network node.

In some example embodiments, the computer program code may be further configured to cause the apparatus at least to: send, by the UE to the first network node, a first measurement report including cell quality measurements of the serving cell and one or more of the first cells, wherein the first reconfiguration message is received in response to sending the first measurement report.

In some example embodiments, the computer program code may be further configured to cause the apparatus at least to: send, by the UE to the first network node, a reconfiguration complete message in response to receiving the first reconfiguration message; send, by the UE to the first network node, a layer 1 (L1) measurement report related to one or more of the first cells to trigger execution of the mobility procedure; and in response to receiving, from the first network node, a cell change command to change to the first target cell, execute, by the UE, the mobility procedure to change from the serving cell to the first target cell.

In some example embodiments, the first reconfiguration message may comprise one or more PreparedCellConfig information elements defining a set of parameters to one or more first cells, the PreparedCellConfig information elements representing the first cell-specific configurations.

In some example embodiments, the computer program code may be further configured to cause the apparatus at least to: receive, by the UE from the first network node, a second reconfiguration message including a second base configuration common to a plurality of second cells served by a second network node and a plurality of second cell-specific configurations each related to one of the plurality of second cells to enable execution of the mobility procedure; and apply, by the UE upon execution of the mobility procedure, the second base configuration and a second cell-specific configuration for a second target cell from among the plurality of second cell-specific configurations to connect the UE to the second target cell.

In some example embodiments, the computer program code may be further configured to cause the apparatus at least to: store, by the UE, the second base configuration and the plurality of second cell-specific configurations for the second network node.

In some example embodiments, the computer program code may be further configured to cause the apparatus at least to: send, by the UE to the first network node, a second measurement report related to one or more of the second cells, wherein the second reconfiguration message is received in response to sending the second measurement report.

In some example embodiments, the computer program code may be further configured to cause the apparatus at least to: in response to receiving, from the first network node, a handover command to change to the second target cell, execute, by the UE, the mobility procedure to change from the serving cell to the second target cell.

In some example embodiments, the second base configuration is further common to the plurality of first cells.

In some example embodiments, the second reconfiguration message may comprise one or more PreparedCellConfig information elements defining a set of parameters to one or more second cells, the PreparedCellConfig information elements representing the second cell-specific configurations.

In some example embodiments, a PreparedCellConfig information element may comprise at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FR1 indicating power to be used in the prepared cell.

In some example embodiments, the computer program code may be further configured to cause the apparatus at least to: replace, by the UE, at least part of a stored base configuration received with a previous reconfiguration message based on the set of parameters of the one or more PreparedCellConfig information elements; and initiate, by the UE, a random-access procedure.

In some example embodiments, the mobility procedure may comprise a layer 1 (L1)/layer 2 (L2) mobility procedure.

According to a second aspect of the subject disclosure, a method in a user equipment (UE) connected to a serving cell, is provided. The method comprises: receiving, from a first network node, a first reconfiguration message including a first base configuration common to a plurality of first cells served by the first network node and a plurality of first cell-specific configurations each related to one of the plurality of first cells to enable execution of a mobility procedure; and applying, upon execution of the mobility procedure, at least a cell-specific configuration for a first target cell from among the plurality of first cell-specific configurations to connect the UE to the first target cell.

According to a third aspect of the subject disclosure, an apparatus comprises at least one processor; and at least one memory including computer program code. The at least one memory and the computer program code are configured to cause the apparatus at least to: send, by a first network node to a user equipment (UE) connected to a serving cell, a first reconfiguration message including a first base configuration common to a plurality of first cells served by the first network node and a plurality of first cell-specific configurations each related to one of the plurality of first cells to enable execution of a mobility procedure; and send, by the first network node to the UE, a cell change command to trigger execution of a mobility procedure by the UE to apply at least a cell-specific configuration for a first target cell from among the plurality of first cell-specific configurations to change from the serving cell and connect the UE to the first target cell.

In some example embodiments, the computer program code may be further configured to cause the apparatus at least to: receive, by the first network node from the UE, a first measurement report including cell quality measurements of the serving cell and one or more of the first cells, wherein the first reconfiguration message is sent in response to receiving the first measurement report.

In some example embodiments, the computer program code may be further configured to cause the apparatus at least to: receive, by the first network node from the UE, a reconfiguration complete message in response to sending the first reconfiguration message; and receive, by the first network node from the UE, a layer 1 (L1) measurement report related to one or more of the first cells to trigger execution of the mobility procedure, wherein the cell change command is sent in response to receiving the L1 measurement report.

In some example embodiments, the first reconfiguration message may comprise one or more PreparedCellConfig information elements defining a set of parameters to one or more first cells, the PreparedCellConfig information elements representing the first cell-specific configurations.

In some example embodiments, the computer program code may be further configured to cause the apparatus at least to: send, by the first network node to the UE, a second reconfiguration message including a second base configuration common to a plurality of second cells served by a second network node and a plurality of second cell-specific configurations each related to one of the plurality of second cells to enable execution of the mobility procedure; and send, by the first network node to the UE, a handover command to trigger execution of a mobility procedure by the UE to apply the second base configuration and a second cell-specific configuration for a second target cell from among the plurality of second cell-specific configurations to change from the serving cell and connect the UE to the second target cell.

In some example embodiments, the computer program code may be further configured to cause the apparatus at least to: receive, by the first network node from the UE, a second measurement report related to one or more of the second cells, wherein the second reconfiguration message is sent in response to receiving the second measurement report.

In some example embodiments, the second base configuration may be further common to the plurality of first cells.

In some example embodiments, the computer program code may be further configured to cause the apparatus at least to: send, by the first network node to the second network node, a request to prepare the second base configuration and the plurality of second cell-specific configurations; and receive, by the first network node from the second network node, a message including the second base configuration and the second plurality of cell-specific configurations.

In some example embodiments, the second reconfiguration message may comprise one or more PreparedCellConfig information elements defining a set of parameters to one or more second cells, the PreparedCellConfig information elements representing the second cell-specific configurations.

In some example embodiments, a PreparedCellConfig information element may comprise at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FRI indicating power to be used in the prepared cell.

In some example embodiments, the mobility procedure may comprise a layer 1 (L1)/layer 2 (L2) mobility procedure.

According to a fourth aspect of the subject disclosure, a method in a first network node is provided. The method comprises: sending, to a user equipment (UE) connected to a serving cell, a first reconfiguration message including a first base configuration common to a plurality of first cells served by the first network node and a plurality of first cell-specific configurations each related to one of the plurality of first cells to enable execution of a mobility procedure; and sending, to the UE, a cell change command to trigger execution of a mobility procedure by the UE to apply at least a cell-specific configuration for a first target cell from among the plurality of first cell-specific configurations to change from the serving cell and connect the UE to the first target cell.

According to a fifth aspect of the subject disclosure, an apparatus comprises at least one processor; and at least one memory including computer program code. The at least one memory and the computer program code are configured to cause the apparatus at least to: send, by a first network node to a second network node, a request to prepare a base configuration common to a plurality of cells served by the second network node and a plurality of cell-specific configurations each related to one of the plurality of cells; and receive, by the first network node from the second network node, a message including the base configuration and the plurality of cell-specific configurations.

In some example embodiments, the computer program code may be further configured to cause the apparatus at least to: send, by the first network node to a UE, a reconfiguration message including the base configuration and the plurality of cell-specific configurations; and send, by the first network node to the UE, a handover command to trigger execution of a mobility procedure by the UE to apply the base configuration and a cell-specific configuration for a target cell from among the plurality of cell-specific configurations to connect the UE to the target cell.

In some example embodiments, the computer program code may be further configured to cause the apparatus at least to: receive, by the first network node from the UE, a measurement report related to one or more of the cells, wherein the request is sent in response to receiving the measurement report.

In some example embodiments, the computer program code may be further configured to cause the apparatus at least to: use, by the first network node, the base configuration for the second network node to prepare a plurality of cell-specific configurations each related to one of a plurality of cells served by the first network node.

According to a sixth aspect of the subject disclosure, a method in a first network node is provided. The method comprises: sending, to a second network node, a request to prepare a base configuration common to a plurality of cells served by the second network node and a plurality of cell-specific configurations each related to one of the plurality of cells; and receiving, from the second network node, a message including the base configuration and the plurality of cell-specific configurations.

According to a seventh aspect of the subject disclosure, an apparatus comprises at least one processor; and at least one memory including computer program code. The at least one memory and the computer program code are configured to cause the apparatus at least to:

receive, by a second network node from a first network node, a request to prepare a base configuration common to a plurality of cells served by the second network node and a plurality of cell-specific configurations each related to one of the plurality of cells; and send, by the second network node to the first network node, a message including the base configuration and the plurality of cell-specific configurations.

In some example embodiments, the computer program code may be further configured to cause the apparatus at least to: allocate, by the second network node, the base configuration and the plurality of cell-specific configurations for the plurality of cells.

According to an eighth aspect of the subject disclosure, a method in a second network node is provided. The method comprises receiving, from a first network node, a request to prepare a base configuration common to a plurality of cells served by the second network node and a plurality of cell-specific configurations each related to one of the plurality of cells; and sending, to the first network node, a message including the base configuration and the plurality of cell-specific configurations.

According to a ninth aspect of the subject disclosure, a computer program product comprising program instructions stored on a computer readable medium to execute a method according to the second, fourth, sixth and/or eighth when said program is executed on a computer.

The above-noted aspects and features may be implemented in systems, apparatuses, methods, articles and/or non-transitory computer-readable media depending on the configuration. The subject disclosure may be implemented in and/or used with a number of different types of devices, including but not limited to cellular phones, tablet computers, wearable computing devices, portable media players, and any of various other computing devices.

This summary is intended to provide a brief overview of some of the aspects and features according to the subject disclosure. Accordingly, it will be appreciated that the above-described features are merely examples and should not be construed to narrow the scope of the subject disclosure in any way. Other features, aspects, and advantages of the subject disclosure will become apparent from the following detailed description, drawings, and claims.

### BRIEF DESCRIPTION OF THE DRAWINGS

A better understanding of the subject disclosure can be obtained when the following detailed description of various example embodiments is considered in conjunction with the following drawings, in which:

FIG. 1 shows a simplified schematic diagram of an example communications system according to aspects of the subject disclosure;

FIG. 2 shows a more detailed schematic diagram of the example communications system according to aspects of the subject disclosure;

FIG. 3 is a diagram illustrating a disaggregated gNB architecture according to aspects of the subject disclosure;

FIG. 4 is a diagram illustrating an intra-gNB-DU deployment according to aspects of the subject disclosure;

FIG. 5 shows a schematic diagram of an example mobile communication device according to aspects of the subject disclosure;

FIG. 6 shows a schematic diagram of an example control apparatus according to aspects of the subject disclosure;

FIG. 7 shows an exemplary implementation for a signaling diagram of L1/L2 inter-cell mobility according to aspects of the subject disclosure;

FIG. 8 illustrates issues related to the exemplary implementation for the signaling diagram of L1/L2 inter-cell mobility of FIG. 7;

FIG. 9 illustrates general principles according to some example embodiments of the subject disclosure;

FIGS. 10 to 14 illustrate flow charts of methods for efficient configuration of L1/L2 mobility according to some example embodiments;

FIG. 15 is an exemplary sequence diagram illustrating an optimized intra-gNB and inter-gNB L1/L2 mobility signalling according to some example embodiments;

FIG. 16 is an exemplary sequence diagram illustrating an optimized intra-gNB L1/L2 mobility intra-DU and inter-DU case signaling according to some example embodiments; and

FIG. 17 is an exemplary sequence diagram illustrating MN and SN communication for L1/L2 mobility signalling, according to some example embodiments.

### DETAILED DESCRIPTION

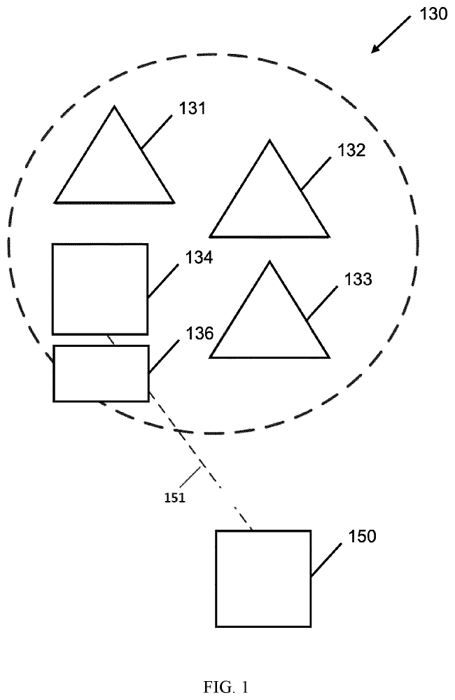

Before explaining the examples in detail, certain principles of a wireless communications system and mobile communication devices are briefly explained with reference to FIGS. 1 to 6 to assist in understanding the technology underlying the described examples.

FIG. 1 is a simplified block diagram of an example communications system such as a wireless network 130 according to aspects of the subject disclosure.

In the wireless network 130 of FIG. 1, user devices 131, 132, and 133, which may also be referred to as communication devices, mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e) Node B (eNB) may also be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network (CN) 150 via an interface 151. This is merely one simple example of a wireless network, and others may be used.

A user device (communication device, user terminal, UE) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

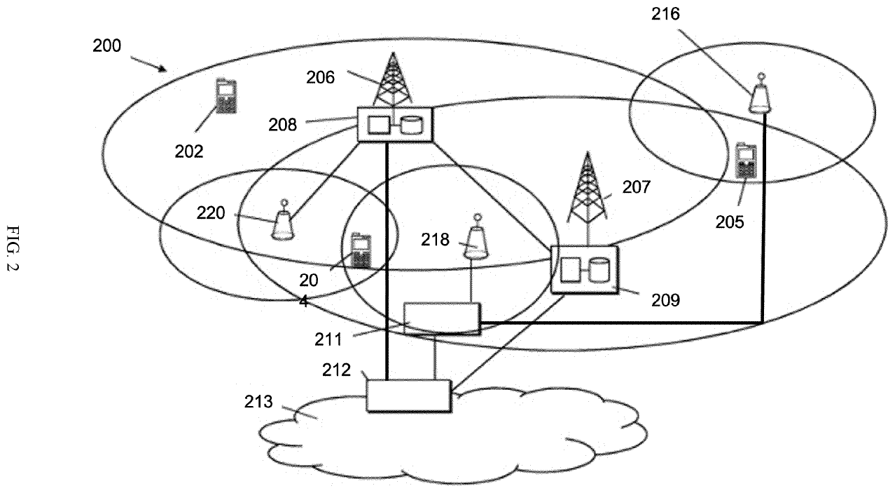

FIG. 2 is another schematic diagram of the example communications system according to aspects of the subject disclosure, showing further details thereof.

In the wireless communications system 200 which may be the wireless network 130 of FIG. 1, the communication devices or UEs 202, 204, 205 (which may correspond to the UEs 131, 132, 133 shown in FIG. 1) are provided wireless access via at least one base station (e.g., next generation NB, gNB) or similar wireless transmitting and/or receiving node or point. Base stations may be controlled or assisted by at least one appropriate controller apparatus, so as to enable operation thereof and management of communication devices in communication with the base stations. The controller apparatus may be located in a radio access network (e.g., the wireless communication system 200) or in a core network (CN) (not shown) and may be implemented as one central apparatus or its functionality may be distributed over several apparatuses. The controller apparatus may be part of the base station and/or provided by a separate entity such as a Radio Network Controller (RNC). In FIG. 1, control apparatuses 208 and 209 are shown to control the respective macro level base stations 206 and 207. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a RNC.

The base stations 206 and 207 shown in FIG. 2 (which may correspond to the BS shown in FIG. 1) are shown as connected to a wider communications network 213 via gateway 212. A further gateway function may be provided to connect to another network.

As used herein, the term “base station” has the full breadth of its ordinary meaning, and at least includes a wireless communication station installed at a fixed location and used to communicate as part of a wireless telephone system or radio system. The communication area (or coverage area) of the base stations may be referred to as a “cell” (e.g., the cell 136 shown in FIG. 1). The base stations and the UEs may be configured to communicate over the transmission medium using any of various radio access technologies (RATs), also referred to as wireless communication technologies, or telecommunication standards described hereinbelow. As illustrated in FIG. 1, while one of the base stations may act as a “serving cell” for UEs, each UE may also be capable of receiving signals from (and possibly within communication range of) one or more other cells (which might be provided by the base stations and/or any other base stations), which may be referred to as “neighboring cells”.

The smaller base stations 216, 218 and 220 may also be connected to the network 213, for example by a separate gateway function and/or via the controllers of the macro level stations. The base stations 216, 218 and 220 may be pico or femto level base stations or the like. In the example, stations 216 and 218 are connected via a gateway 211 whilst station 220 connects via the controller apparatus 208. In some example embodiments, the smaller stations may not be provided. Smaller base stations 216, 218 and 220 may be part of a second network, for example WLAN and may be WLAN APs. The communication devices 202, 204, 205 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communications systems are architectures standardized by the 3rd Generation Partnership Project (3GPP). One 3GPP based development is often referred to as the long-term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (LTE-A) employs a radio mobile architecture referred to as the Evolved Universal Terrestrial Radio Access Network (E-UTRAN) and a core network known as the Evolved Packet Core (EPC). Base stations of such systems are referred to as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area. Core network elements include Mobility Management Entity (MME), Serving Gateway (S-GW) and Packet Gateway (P-GW). Other example implementations may be applied to wireless technologies/wireless networks, such as cmWave, and/or mmWave band networks, or any other wireless network or use case. LTE, 5G, etc. are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IoT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

An example of a communications system is the 5G or NR concept. Network architecture in NR may be compared to that of LTE Advanced. Base stations of NR systems may be referred to as next generation Node Bs (gNBs). Changes to the network architecture may depend on the need to support various radio technologies and finer QoS support, and some on-demand requirements for e.g. QoS levels to support QoE of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Networks may utilize network functions virtualization (NFV) which is a network architecture concept that virtualize network node functions into “building blocks” or entities that may be operationally connected or linked together to provide services. A virtualized network function (VNF) may comprise one or more virtual machines running computer program codes using servers. Cloud computing or data storage may also be utilized. In radio communications, this may mean node operations to be carried out, at least partly, in a server, host or node operationally coupled to a remote radio head. It is also possible that node operations may be distributed among a plurality of servers, nodes, or hosts. It should also be understood that the distribution of labor between core network operations and base station operations may differ from that of the LTE or even be non-existent.

An example 5G core network (CN) comprises functional entities. The CN is connected to a UE via the radio access network (RAN). An UPF (User Plane Function) whose role is called PSA (PDU Session Anchor) may be responsible for forwarding frames back and forth between the DN (data network) and the tunnels established over the 5G towards the UE(s) exchanging traffic with the DN. The UPF is controlled by an SMF (Session Management Function) that receives policies from a PCF (Policy Control Function). The CN may also include an AMF (Access & Mobility Function).

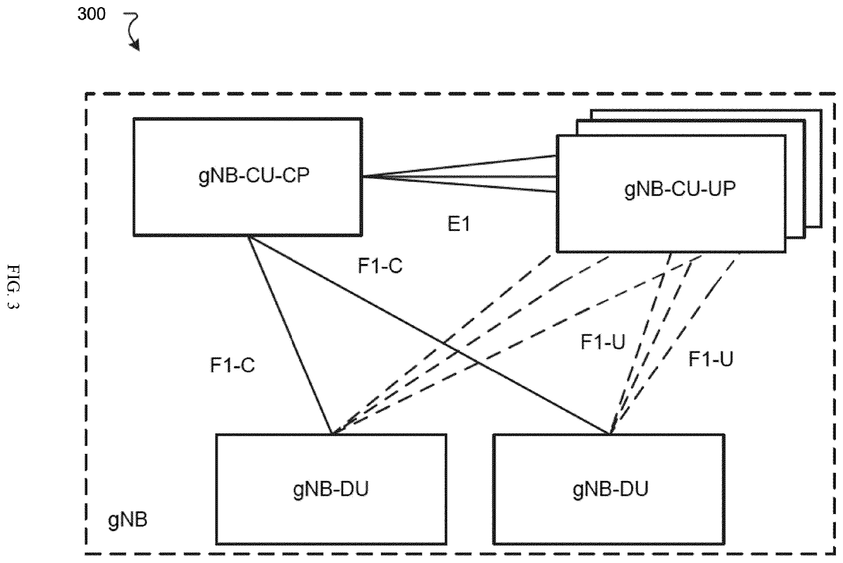

FIG. 3 is a diagram illustrating a disaggregated gNB architecture according to aspects of the subject disclosure.

Such a disaggregated architecture is defined in the 3GPP standard as a decomposition of a network node (gNB) into multiple logical entities. In the architecture 300 shown in FIG. 3, a gNB has a central unit (gNB-CU) and distributed units (gNB-DUs). As shown in FIG. 3, the gNB-CU itself is split into a control plane component (gNB-CU-CP) and a user plane component (gNB-CU-UP). The gNB-CU-CP is connected to the gNB-CU-UP via an E1 connection, the gNB-DUs are connected to the gNB-CU-CP via a F1-C connection, and the gNB-DUs are connected to the gNB-CU-UP via a F1-U connection.

In such a disaggregated architecture as that shown in FIG. 3, a gNB-DU may host multiple cells up to a maximum of 512 according to current specifications. Accordingly, serving cell change between cells may be considered intra-DU for a serving cell change between cells of the same gNB-DU, and inter-DU between cells of different gNB-DUs.

In conventional approaches to mobility events, UE reports layer 1 (L1) and layer 3 (L3) measurements to the gNB-DU and gNB-CU, respectively. L1 beam measurements are reported to MAC layer and used for beam management in the gNB-DU, and are not forwarded to the gNB-CU. In contrast, L3 measurements (i.e., cell measurements including optional beam measurements) are reported using RRC protocol and used for mobility management. The L3 measurements are forwarded to the gNB-CU by the gNB-DU. Beam changes are managed by gNB-DU and cell changes, regardless of whether the mobility is intra-DU or inter-DU, are triggered/managed by the gNB-CU-CP.

In the conventional approaches to mobility events, the gNB-CU-CP determines the triggering of an L3 mobility procedure based on received L3 measurements. For intra-DU cell changes, this incurs additional time due to the exchange of signaling messages, particularly in a distributed cloud deployment where there is an external F1/E1 interface. For instance, after UE sends the measurement report, the measurements have to be forwarded to the CU-CP which will then request and perform the UE context modification at the target cell which belongs to the same gNB-DU, and send an RRC Reconfiguration (serving cell change command) to the UE via the gNB-DU. The gNB-DU is then able to forward the serving cell change command to the UE.

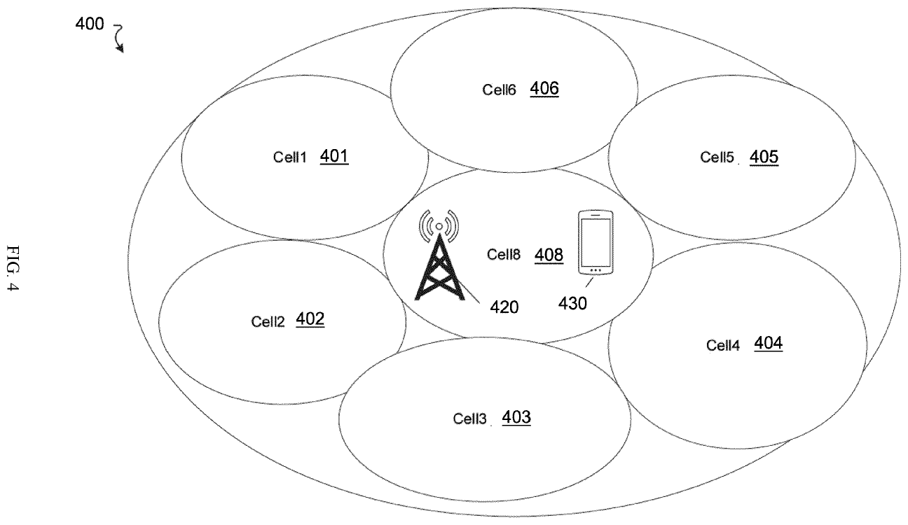

FIG. 4 is a diagram illustrating an intra-gNB-DU deployment according to aspects of the subject disclosure.

FIG. 4 shows a gNB-DU 400 with intra-frequency cells 401-406 and 408, i.e., cells that operate over the same frequency band. As shown in FIG. 4, UE 430 moves from Cell1 401 to Cell8 408. Initially the UE resides at the edge of Cell1 401, then the UE subsequently moves to Cell8 408 and later to the edge of the Cell8 408. When the UE 430 resides in Cell1 401, the neighboring cells for the UE are Cell2 402 and Cell8 408. When the UE 430 resides in Cell8 408, the neighboring cells for the UE are Cell6 406 and Cell5 405.

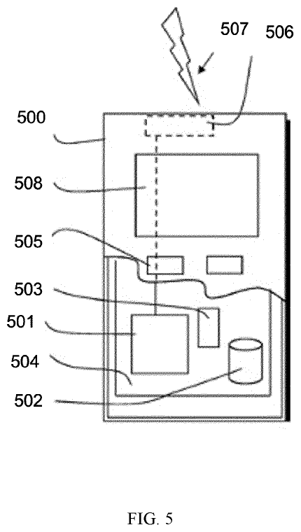

A possible communication device will now be described in more detail with reference to FIG. 5 showing a schematic, partially sectioned view of a communication device 500. Such a communication device is often referred to as UE or terminal device. A communication device may be implemented by any device capable of sending and receiving radio signals. Non-limiting examples comprise a mobile station (MS) or mobile device, such as a mobile phone or what is referred to as a smart phone, a computer provided with a wireless interface card or other wireless interface facility (e.g., USB dongle), personal data assistant (PDA) or a tablet provided with wireless communication capabilities, or any combinations of these or the like. A communication device may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

In an industrial application a communication device may be a modem integrated into an industrial actuator (e.g., a robot arm) and/or a modem acting as an Ethernet-hub that will act as a connection point for one or several connected Ethernet devices (which connection may be wired or unwired).

A communication device 500 is typically provided with at least one data processing entity 501, at least one memory 502 and other possible components 503 for use in software and hardware aided execution of tasks it is designed to perform, including control of access to and communications with access systems and other communication devices. The data processing, storage and other relevant control apparatus can be provided on an appropriate circuit board and/or in chipsets (denoted by 504). The user may control the operation of the communication device 500 by means of a suitable user interface such as keypad 505, voice commands, touch sensitive screen or pad, combinations thereof or the like. A display 508, a speaker and a microphone can be also provided. Furthermore, a communication device may comprise appropriate connectors (either wired or wireless) to other devices and/or for connecting external accessories, for example hands-free equipment, thereto.

The communication device 500 may receive signals over an air or radio interface 507 via appropriate apparatus for receiving and may transmit signals via appropriate apparatus for transmitting radio signals. In FIG. 5, transceiver apparatus is designated schematically by block 506. The transceiver apparatus 506 may be provided, for example, by means of a radio part and associated antenna arrangement. The antenna arrangement may be arranged internally or externally to the communication device.

Generally, the communication device 500 shown in FIG. 5 includes a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 500.

The communication device 500 may include at least one antenna in communication with a transmitter and a receiver (e.g., the transceiver apparatus 506). Alternatively, transmit and receive antennas may be separate. The communication device 500 may also include a processor (e.g., the at least one data processing entity 501) configured to provide signals to and receive signals from the transmitter and receiver, respectively, and to control the functioning of the communication device 500. The processor may be configured to control the functioning of the transmitter and receiver by effecting control signaling via electrical leads to the transmitter and receiver. Likewise, the processor may be configured to control other elements of the communication device 500 by effecting control signaling via electrical leads connecting processor to the other elements, such as a display (e.g., display 508) or a memory (e.g., the at least one memory 502). The processor may, for example, be implemented in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, in some examples, the processor may comprise a plurality of processors or processing cores.

The communication device 500 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the communication device 500 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like). For example, the communication device 500 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the communication device 500 may be capable of operating in accordance with 2.5G wireless communication protocols General Packet Radio Service (GPRS), Enhanced Data GSM Environment (EDGE), and/or the like. Further, for example, the communication device 500 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The communication device 500 may be additionally capable of operating in accordance with 3.9G wireless communication protocols, such as Long-Term Evolution (LTE), Evolved Universal Terrestrial Radio Access Network (E-UTRAN), and/or the like. Additionally, for example, the communication device 500 may be capable of operating in accordance with 4G wireless communication protocols, such as LTE Advanced, 5G, and/or the like as well as similar wireless communication protocols that may be subsequently developed.

It is understood that the processor may include circuitry for implementing audio/video and logic functions of the communication device 500. For example, the processor may comprise a digital signal processor device, a microprocessor device, an analog-to-digital converter, a digital-to-analog converter, and/or the like. Control and signal processing functions of the communication device 500 may be allocated between these devices according to their respective capabilities. The processor may additionally comprise an internal voice coder (VC), an internal data modem (DM), and/or the like. Further, the processor may include functionality to operate one or more software programs, which may be stored in memory. In general, the processor and stored software instructions may be configured to cause the communication device 500 to perform actions. For example, the processor may be capable of operating a connectivity program, such as a web browser. The connectivity program may allow the communication device 500 to transmit and receive web content, such as location-based content, according to a protocol, such as wireless application protocol (WAP), hypertext transfer protocol (HTTP), and/or the like.

The communication device 500 may also comprise a user interface including, for example, an earphone or speaker, a ringer, a microphone, a display, a user input interface, and/or the like, which may be operationally coupled to the processor. The display may, as noted above, include a touch sensitive display, where a user may touch and/or gesture to make selections, enter values, and/or the like. The processor may also include user interface circuitry configured to control at least some functions of one or more elements of the user interface, such as the speaker, the ringer, the microphone, the display, and/or the like. The processor and/or user interface circuitry comprising the processor may be configured to control one or more functions of one or more elements of the user interface through computer program instructions, for example, software and/or firmware, stored on a memory accessible to the processor, for example, volatile memory, non-volatile memory, and/or the like. The communication device 500 may include a battery for powering various circuits related to the mobile terminal, for example, a circuit to provide mechanical vibration as a detectable output. The user input interface may comprise devices allowing the communication device 500 to receive data, such as a keypad (e.g., keypad 505) and/or other input devices. The keypad can also be a virtual keyboard presented on display or an externally coupled keyboard.

The communication device 500 may also include one or more mechanisms for sharing and/or obtaining data. For example, the communication device 500 may include a short-range radio frequency (RF) transceiver and/or interrogator, so data may be shared with and/or obtained from electronic devices in accordance with RF techniques. The communication device 500 may include other short-range transceivers, such as an infrared (IR) transceiver, a Bluetooth™ (BT) transceiver operating using Bluetooth™ wireless technology, a wireless universal serial bus (USB) transceiver, a Bluetooth™ Low Energy transceiver, a ZigBee transceiver, an ANT transceiver, a cellular device-to-device transceiver, a wireless local area link transceiver, and/or any other short-range radio technology. The communication device 500 and in particular, the short-range transceiver may be capable of transmitting data to and/or receiving data from electronic devices within the proximity of the apparatus, such as within 10 meters, for example. The communication device 500 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The communication device 500 may comprise memory, such as one or more Subscriber Identity Modules (SIM), one or more Universal Subscriber Identity Modules (USIM), one or more removable User Identity Modules (R-UIM), one or more eUICC, one or more UICC, and/or the like, which may store information elements related to a mobile subscriber. In addition, the communication device 500 may include other removable and/or fixed memory. The communication device 500 may include volatile memory and/or non-volatile memory. For example, the volatile memory may include Random Access Memory (RAM) including dynamic and/or static RAM, on-chip, or off-chip cache memory, and/or the like. The non-volatile memory, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory, the non-volatile memory may include a cache area for temporary storage of data. At least part of the volatile and/or non-volatile memory may be embedded in the processor. The memories may store one or more software programs, instructions, pieces of information, data, and/or the like which may be used by the apparatus for performing operations disclosed herein.

The memories may comprise an identifier, such as an International Mobile Equipment Identification (IMEI) code, capable of uniquely identifying the communication device 500. The memories may comprise an identifier, such as an international mobile equipment identification (IMEI) code, capable of uniquely identifying the communication device 500. In some example embodiments, the processor may be configured using computer code stored at memory to cause the processor to perform operations disclosed herein.

Some of the example embodiments disclosed herein may be implemented in software, hardware, application logic, or a combination of software, hardware, and application logic. The software, application logic, and/or hardware may reside on the memory, the processor, or electronic components, for example. In some example embodiments, the application logic, software, or an instruction set is maintained on any one of various computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 5, computer-readable medium may comprise a non-transitory computer-readable storage medium that may be any media that can contain or store the instructions for use by or in connection with an instruction execution system, apparatus, or device, such as a computer.

In some example embodiments, the communication device 500 (i.e., UE in a network) comprises the processor (e.g., the at least one data processing entity 501) and the memory (e.g., the at least one memory 502). The memory includes computer program code causing the communication device 500 to perform processing according to one or more of the methods for efficient configuration of L1/L2 mobility according to some example embodiments of the subject disclosure, as described below.

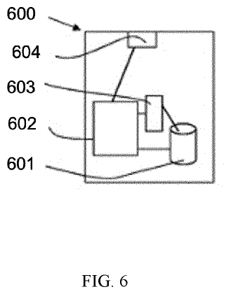

FIG. 6 shows an example control apparatus 600 for a communication system, for example to be coupled to and/or for controlling a station of an access system, such as a RAN node, e.g., a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some examples, base stations comprise a separate control apparatus unit or module. In other examples, the control apparatus can be another network element, such as a radio network controller or a spectrum controller. In some examples, each base station may have such a control apparatus as well as a control apparatus being provided in a radio network controller. The control apparatus 600 can be arranged to provide control on communications in the service area of the system. The control apparatus 600 comprises at least one memory 601, at least one data processing unit 602, 603 and an input/output interface 604. Via the interface, the control apparatus 600 can be coupled to a receiver and a transmitter of the base station. The receiver and/or the transmitter may be implemented as a radio front end or a remote radio head.

Generally, the control apparatus 600 has an antenna, which transmits and receives radio signals. A radio frequency (RF) transceiver module, coupled with the antenna, receives RF signals from antenna, converts them to baseband signals and sends them to processor (e.g., the at least one data processing unit 602, 603). RF transceiver also converts received baseband signals from processor, converts them to RF signals, and sends out to antenna. Processor processes the received baseband signals and invokes different functional modules to perform features in control apparatus 600. Memory (e.g., the at least one memory 601) stores program instructions and data to control the operations of the control apparatus 600. In the example of FIG. 6, the control apparatus 600 also includes protocol stack and a set of control functional modules and circuit. PDU session handling circuit handles PDU session establishment and modification procedures. Policy control module that configures policy rules for UE. Configuration and control circuit provides different parameters to configure and control UE of related functionalities including mobility management and session management. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines.

In some examples, the control apparatus 600 (i.e., the base station or the wireless transmitting and/or receiving point equipment) comprises the processor (e.g., the at least one data processing unit 602, 603) and the memory (e.g., the at least one memory 601). The memory includes computer program code causing the control apparatus 600 to perform processing according to the methods for efficient configuration of L1/L2 mobility according to some example embodiments of the subject disclosure, as described below.

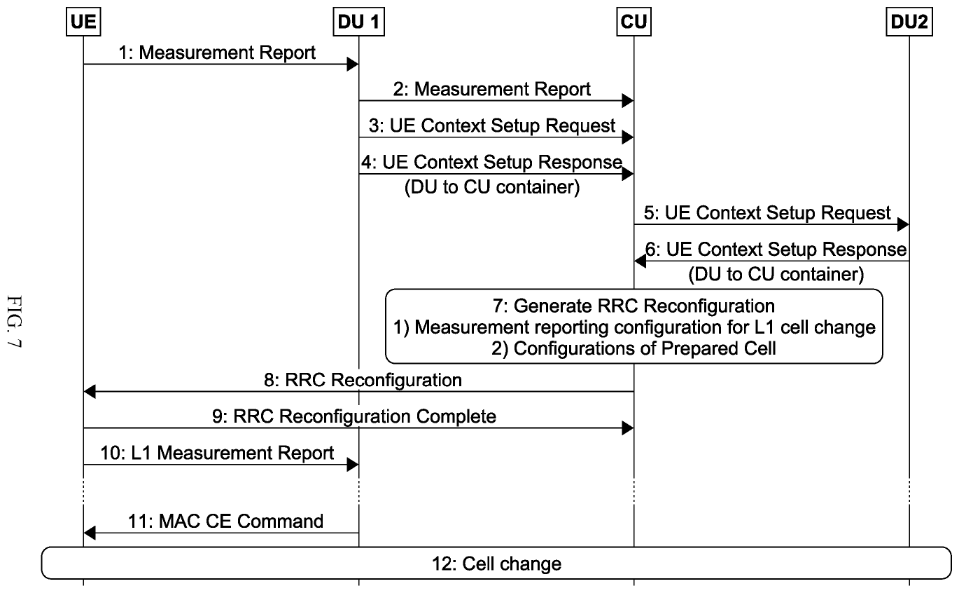

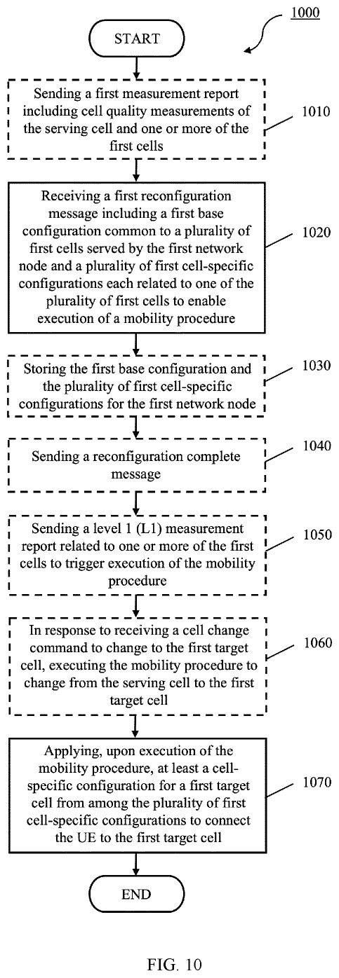

Before referring to FIGS. 10 to 17 to describe the methods for efficient configuration of L1/L2 mobility according to some example embodiments of the subject disclosure, some additional information and aspects pertaining to the subject disclosure will be provided with reference to FIGS. 7 to 9.

Layer 1 (L1)/Layer 2 (L2) mobility is one of the objectives for mobility enhancement in Release 18 of the 3GPP standard. Specifically, L1/L2 mobility from one cell to another cell (referred to as L1/L2 inter-cell mobility) will be addressed. In contrast to Layer 3 (L3) mobility procedures where a handover between two cells is decided by RRC layer, L1/L2 inter-cell mobility is performed by the MAC layer terminated in a network node (e.g., a base station gNB, or a distributed unit DU of a base station in a disaggregated architecture).

Referring now the illustration of FIG. 7, an exemplary implementation for a signaling diagram of L1/L2 inter-cell mobility from a serving cell in a first distributed unit DU1 to a target cell in a second distributed unit DU2 (i.e., inter-DU intra-CU scenario) will be described. Even if the exemplary implementation is described for the inter-DU intra-CU scenario, it is to be understood that the same signaling diagram applies as well in case of intra-DU intra-CU cell change where the first distributed unit DU 1 would be the same as the second distributed unit DU2.

The L1/L2 inter-cell mobility may be implemented in a network such as a 5G network. More specifically, the L1/L2 inter-cell mobility may be implemented in a network using the disaggregated gNB architecture shown in FIG. 3. That is, the network includes one or more network nodes such as base stations (e.g., the base station 420 shown in FIG. 4) decomposed into multiple logical entities. For example, the network includes a base station gNB1 decomposed into a central unit (also referred to as gNB-CU or CU) and multiple distributed units (referred to as gNB-DUs or DUs) including the first distributed unit DU1 and the second distributed unit DU2. The network also includes a mobile device such as the UE 430 shown in FIG. 4 (e.g., UE). The base station serves a plurality of cells. In the disaggregated gNB architecture, the first distributed unit DU1 serves a plurality of first cells and the second distributed unit DU2 serves a plurality of second cells. The central unit of the base station controls operations of the distributed units.

At step 1, the UE sends a measurement report containing cell quality measurements of serving and neighboring cells to the central unit CU. The serving cell may be a cell of the plurality of first cells served by the first distributed unit DU1 and the neighboring cells may comprise one or more cells of the plurality of first cells served by the first distributed unit DU1 or the plurality of second cells served by the second distributed unit DU2. The UE may be configured by the serving cell to send the measurement report when the UE still has a good connection to the serving cell.

At step 2, using the cell quality measurements received at step 1, the central unit CU identifies a potential set of candidate target cells (i.e., cells among the plurality of first cells and the plurality of second cells) to which the UE can be handed over to. In this example, the central unit CU identifies candidate target cells that are served by first distributed unit DU1 (controlling the serving distributed unit DU/cell as well) and another distributed unit such as the second distributed unit DU2 that is controlled by the same central unit CU.

At step 3, the central unit CU requests preparation of a candidate target cell controlled by the first distributed unit DU1. For example, the central unit CU request the preparation by sending a corresponding request message (e.g., UE Context Setup Request message) to the first distributed unit DU1.

At step 4, the first distributed unit DU1 provides the configuration of the UE to the central unit CU. For example, the first distributed unit DU1 provides the configuration in a response message (e.g., UE Context Setup Response message) containing a radio configuration message container from distributed unit DU to central unit CU.

At step 5, the central unit CU requests preparation of a candidate target cell controlled by the second distributed unit DU2. For example, the central unit CU request the preparation by sending a corresponding request message (e.g., UE Context Setup Request message) to the second distributed unit DU2.

At step 6, the second distributed unit DU2 provides the configuration of the UE to the central unit CU. For example, the second distributed unit DU2 provides the configuration in a response message (e.g., UE Context Setup Response message) containing a container from distributed unit DU to central unit CU.

That is, the same steps 5/6 are performed with the second distributed unit DU2 to prepare the target cell(s) that are controlled by the second distributed unit DU2.

At step 7, the central unit CU generates a reconfiguration message (e.g., an RRC Reconfiguration message) based on the configurations for the candidate target cell(s) received from the first and second distributed units DU1/DU2. The reconfiguration message may include, among other information, measurement reporting configuration for L1/L2 handover (i.e., configuration on how to report the L1 beam measurements of serving and target cells) and configuration of the prepared candidate cell(s) which the UE needs to execute when the UE receives a MAC CE command to change the serving cell (perform handover).

At step 8, the central unit CU sends the reconfiguration message (e.g., the RRC Reconfiguration message) prepared at step 7 to the UE.

After confirming the reconfiguration message (i.e., confirming reception of the RRC Reconfiguration message) to the network at step 9, the UE starts to report (e.g., periodically) the L1 beam measurement of serving and candidate target cell(s) to the first distributed unit at step 10.

Upon determining by the first distributed unit DU1 or the central unit CU that there is a target candidate cell having a better radio link/beam measurement than the serving cell (e.g., L1-RSRP of target beam measurement exceeds L1-RSRP of serving beam measurement plus an offset for an amount of time such as Time-to-Trigger (TTT)), the serving cell sends a MAC Control Element (MAC CE) or a L1 message to the UE at step 11 to trigger the cell change to the target candidate cell. For example, the first distributed unit DU1 may send the MAC CE or L1 message to the UE.

At step 12, the UE executes the handover from serving cell to target cell.

The subject disclosure concerns radio resource configuration aspects related to L1/L2 inter-cell mobility of a UE within a group of cells either within a distributed unit DU or across distributed unit DUs. The aspects of the subject disclosure also relate to L1/L2 mobility between base stations or between nodes in a dual connectivity scenario.

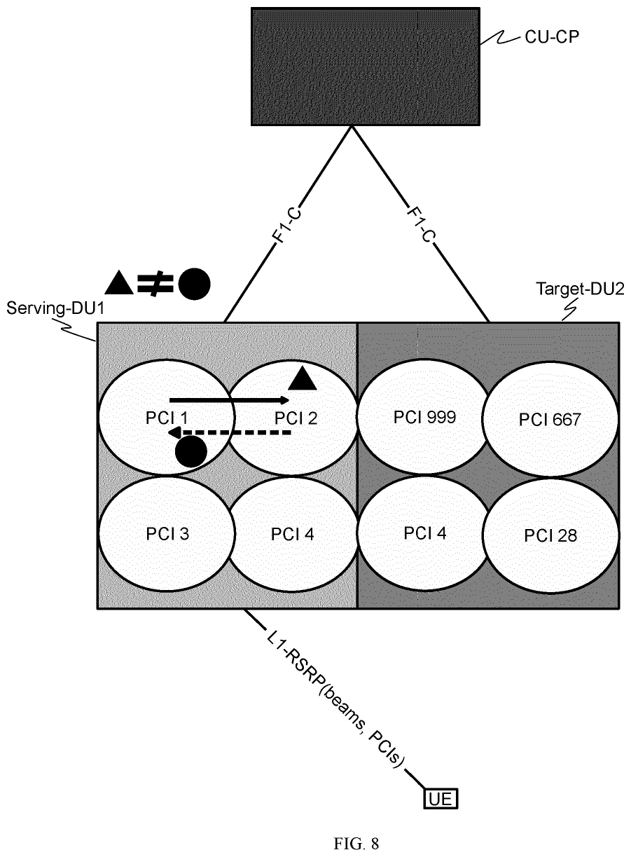

In supporting L1/L2 mobility of the UE in the inter-DU intra-CU scenario described with reference to FIG. 7, the following issues may occur. The issues will be described with reference to FIG. 8.

In FIG. 8, the disaggregated gNB architecture similar to FIG. 3 is shown. The disaggregated gNB architecture includes the central unit (more specifically the control plane of the central unit, CU-CP) and two distributed units DU1/DU2. The first distributed unit DU1 is the serving distributed unit (i.e., the distributed unit that serves the serving cell to which the UE is connected), while the second distributed unit DU2 is the target distributed unit (i.e., the distributed unit that serves the target cell to which the UE is to be handed over to). Each of the distributed units serves a plurality of cells, shown by using a Physical Cell ID (PCI) for each of these cells. The distributed units DU1/DU2 are connected to the central unit (CU-CP) via a F1-C connection, and the UE uses L1 RSRP of beam measurements for cells (identified using the PCI) in signaling with the serving distributed unit DU1.

Now, assuming the UE starts in the serving cell (e.g., PCI1) and requires mobility within cells PCI2, PCI3 and PCI4 all served by the serving distributed unit DU1, a RRC reconfiguration message for the UE in the serving cell PCI1 is required which contains three prepared configurations (e.g., delta configurations) for the cells PCI2, PCI3 and PCI4 and three configuration messages (including full configurations) in case the UE returns back to the serving PCI1 to allow for full-mobility within the area covered by cells PCI1, PCI2, PCI3 and PCI4. That is, full mobility within the area results in the signaling overhead, including three handover preparations to cells PCI2, PCI3 and PCI4; three full configuration preparations from PCI2, PCI3, PCI4 back to PCI1, and one reconfiguration message for PCI1. Thus, the signaling comprises a total of 2N+1 messages with N being the number of prepared target cell(s). The number of total messages and the RRC message size may become large and therefore an issue for efficient signaling.

Another issue related to the large number of total messages and message size is that movement from serving cell PCI1 to any other cell PCIx (i.e., not PCI1) within the serving distributed unit DU1 and back to the serving cell PCI1 may be problematic as there will be two sets of reconfigurations the UE has to store (i.e., the own configuration of the cell for the given PCIx and delta configurations of other cell(s) and a full configuration of PCIx). This may put impossible implementation requirements on the network and the UE in terms of configuration preparation.

A further issue relates to the requirement of reconfiguration with synchronization (sync) in case of using the full configuration messages. In the example of FIG. 8, the UE in first cell PCI1 of the serving distributed unit DU1 moving to a second cell (e.g., PCI2) of the serving distributed unit DU1 requires a delta configuration of the second cell PCI2 on top of the RRC configuration in the first cell PCI1 (or a full configuration). That is, when moving from the first cell PCI1 to the second cell PCI2, the delta configuration (depicted in FIG. 8 by a triangle) from the first cell PCI1 to the second cell PCI2 (depicted in FIG. 8 by a solid line with arrow) is to be applied. In addition, when moving from the second cell PCI2 back to the first cell PCI1, the delta configuration (depicted by the triangle) needs to be reversed (depicted in FIG. 8 by a dashed line with arrow). Reversal basically means undoing changes by applying the configuration (depicted in FIG. 8 by a circle). Typically, the configurations (i.e., the configuration depicted by the triangle and the configuration depicted by the circle) are not the same. In Release 17 of the 3GPP standards, a mechanism of undoing RRC reconfiguration is not supported with RRC signaling. Release 17 in contrast necessitates a full configuration when the UE moves back from the second cell PCI2 to the first cell PCI1. A full configuration is however an unnecessary overhead when considering the assumption that configurations in the cells PCI1/PCI2 may not differ by more than a few parameters (e.g., C-RNTI) and resetting of the whole protocol stack is not desirable from user plane interruption point of view. In sum, to allow mobility from any cell to any other cell within the serving distributed unit DU1 using a MAC CE, RRC configuration delta signaling does not work. The same issue is moving from the serving distributed unit DU1 to the target distributed unit DU2 and back.

The subject disclosure addresses these issues and proposes a solution for efficient configuration of L1/L2 mobility.

According to the subject disclosure, the network should have the flexibility of preparing only a delta configuration for a set of cells which can be applied (e.g., linearly) by a UE. Furthermore, the network should have the flexibility to consider a given delta configuration to be applied with reconfiguration with sync or not as the difference in configuration between two cells participating in L1/L2 mobility based on MAC CE switching does not differ by more than a few configuration parameters.

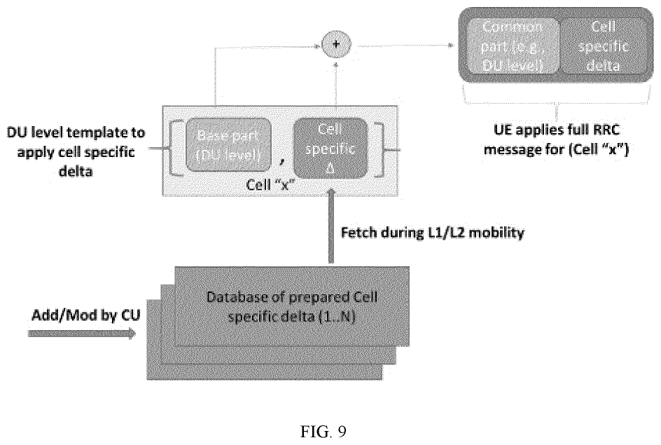

Now, general principles of the subject disclosure will now be described with reference to FIG. 9.

A shown in FIG. 9, cell-specific configurations (e.g., delta configurations) are prepared for the cells served by a base station. For example, cell-specific configurations may be prepared in response to addition or modification by the central unit CU in the disaggregated gNB architecture and stored (e.g., in a database). At the base station, a base configuration (i.e., a base template) may also be prepared. That is, at the base station, the base configuration is prepared by determining the delta between the full configuration for a cell and the cell-specific configuration for the cell. Thus, the combination of the base configuration of the base station and the cell-specific configuration for the cell represent the full configuration for the cell. For example, in the disaggregated gNB architecture, a cell-specific configuration for a cell may be fetched during L1/L2 mobility by the distributed unit DU and the distributed unit may prepare the base configuration for the distributed unit DU using the cell-specific configuration for the cell. At the UE, the base configuration and the cell-specific configuration is applied, thereby applying a full RRC message for the cell.

Now, methods for efficient configuration of L1/L2 mobility according to some example embodiments of the subject disclosure will be described.

FIG. 10 illustrates a flow chart of a method for efficient configuration of L1/L2 mobility according to some example embodiments. The method 1000 is performed by a user equipment (UE) or by an apparatus in the UE. For example, the UE may be represented by any one of the user devices 131, 132, 133 as described above with reference to FIG. 1, mobile communication devices 202, 204, 205 of the wireless communication system 200 as described above with reference to FIG. 2, the communication device 430 as described above with reference to FIG. 4, or the communication device 500 as described above with reference to FIG. 5. More generally, the UE may be represented by any of the communication device described herein.

The UE is connected to a network. More specifically, the UE is connected to a cell served by a network node of the network. The network node (referred to as first network node) such as a base station gNB, a distributed unit DU of a base station gNB in a disaggregated gNB architecture, a master/secondary node MN/SN in a dual connectivity scenario, etc.) serves a plurality of first cells (i.e., one or more first cells). As it will be understood by one of ordinary skill, in the disaggregated gNB architecture, the UE may receive some of the messages described hereinbelow from, or sent such messages to, the distributed unit DU of the base station gNB or a central unit CU of the base station gNB. The cell (referred to as a serving cell) is a cell among the plurality of first cells. To connect the UE to the serving cell, the UE may have performed a connection procedure (e.g., a RRC connection procedure) and established a session (e.g., a PDU session).

At block 1020, the UE receives a reconfiguration message from the first network node. The reconfiguration message is to enable execution of a mobility procedure (e.g., a L1/L2 mobility procedure) to change from the serving cell to another cell. An example of the reconfiguration message comprises a RRC Reconfiguration message. The reconfiguration message comprises a base configuration and a plurality of cell-specific configurations. The base configuration comprises a configuration (e.g., a set of configuration parameters) common to the plurality of first cells served by the first network node, or a set of first cells among the plurality of first cells. Each cell-specific configuration comprises a configuration (e.g., a set of configuration parameters) specific to a cell among the plurality of first cells, or the set of first cells among the plurality of first cells. That is, each cell-specific configuration relates to one of the plurality of first cells (i.e., the cell). In combination, the base configuration and the cell-specific configuration for a cell represent a configuration (i.e., a full/entire configuration message) required by the UE to connect to the cell. In some examples, the cell-specific configuration may be a delta configuration (i.e., delta/increment/change to the base configuration).

Examples of the reconfiguration message comprises one or more PreparedCellConfig information elements. A PreparedCellConfig information element defines a set of parameters to one or more first cells. The PreparedCellConfig information element(s) may represent the cell-specific configurations for the first cells served by the first network node, or the set of first cells among the plurality of first cells. In some examples, a PreparedCellConfig information element comprises at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FRI indicating power to be used in the prepared cell. Further details regarding the reconfiguration message will be provided hereinbelow.

At block 1070, the UE applies a cell-specific configuration for a target cell, from among the plurality of cell-specific configurations. The target cell is a cell among the plurality of first cells served by the first network node. The UE applies the cell-specific configuration for the target cell upon execution of the mobility procedure to connect the UE to the target cell. That is, the UE is to change connection from the serving cell to the target cell. As a result of block 1070, the UE is connected to the target cell.

In some examples, the UE uses a set of parameters according to the cell-specific configuration and applies the set of parameters to the base configuration used by the UE to form a full configuration required to connect to the target cell (i.e., the UE applies the delta configuration according to the cell-specific configuration to the base configuration). In such examples, the UE may have determined that the base configuration used by the UE (i.e., the base configuration used by the UE to connect to the serving cell) corresponds to the base configuration received from the first network node at block 1020. That is, the set of parameters according to the base configuration used by the UE corresponds to the set of parameters according to the base configuration received from the first network node. The UE may compare the base configurations to determine whether they correspond to each other or not. The UE may not only compare whether the base configurations correspond in the parameters included in the sets of parameters but also whether the settings (e.g., value(s)) of the parameters correspond to each other. So, the UE replaces at least part of the cell-specific configuration used to connect to the serving cell by the cell-specific configuration for the target cell, while maintaining the base configuration used by the UE.

In some examples, the UE may apply the base configuration and the cell-specific configuration for the target cell at block 1070. More specifically, the UE may apply the base configuration and the cell-specific configuration, both received at block 1020, if a base configuration applied for the serving cell (i.e., the base configuration used by the UE to connect to the serving cell) differs to the base configuration received from the first network node at block 1020 (i.e., the base configuration for the target cell). That is, the UE may determine that the base configurations do not correspond to each other based on a comparison as described hereinbefore.

In some examples, the UE sends a measurement report to the first network node at block 1010. The measurement report may contain cell quality measurements related to cells. The cells for which cell quality measurements may be contained in the measurement report may include the serving cell and one or more neighboring cells such as cells of the plurality of first cells served by the first network node. The neighboring cells represent candidate target cells (i.e., cells to which the UE can change connection). Based on the cell quality measurements of the measurement report, the first network node can identify a potential set of candidate target cells to which the UE can change connection and prepare the reconfiguration message as will be described in more detail hereinbelow. In response to sending the measurement report, the UE may receive the reconfiguration message from the first network node.

In some other examples, at block 1030, the UE may store the base configuration and the plurality of cell-specific configurations received from the first network node at block 1020. For example, the UE may store the base configuration and the plurality of cell-specific configurations for the first network node in a memory. In response to determining that a base configuration and/or a plurality of cell-specific configurations are received with a previous reconfiguration message and are already stored, the UE may replace at least part of the previous configuration(s) by the respective configuration received from the first network node at block 1020. In some examples, before storing the configurations, the UE may determine based on a comparison as described above whether previous configuration(s) correspond to the respective configuration received from the first network node at block 1020. If the configuration(s) received at block 1020 correspond to the previous configuration(s), the UE does not need to store and thereby replace at least part of the previous configuration(s).

In response to receiving the reconfiguration message at block 1020, the UE may, in some instances, acknowledge reception to the first network node at block 1040. For example, the UE may send a reconfiguration complete message (e.g., a RRC Reconfiguration Complete message) to the first network node. That is, the UE acknowledges to the first network node that the base configuration and the plurality of cell-specific configurations have been received correctly (and stored at the UE) and are ready for use. At block 1050, the UE may send a measurement report related to one or more of the first cells to the first network node. The measurement report may be a layer 1 (L1) measurement report. Based on the L1 measurement report, the first network node decides whether to change the UE from the serving cell to the target cell (i.e., one cell among the first cells served by the first network node or one cell among the potential set of candidate target cells). The execution of the mobility procedure to change from the serving cell to the target cell is triggered in response to the UE receiving a cell change command from the first network node at block 1060. Thus, in response to receiving the cell change command to change to the target cell, the UE applies at least the cell-specific configuration for the target cell at block 1070 to connect to the target cell. The connection to the target cell may be established by the UE by performing a random-access procedure with the first network node.

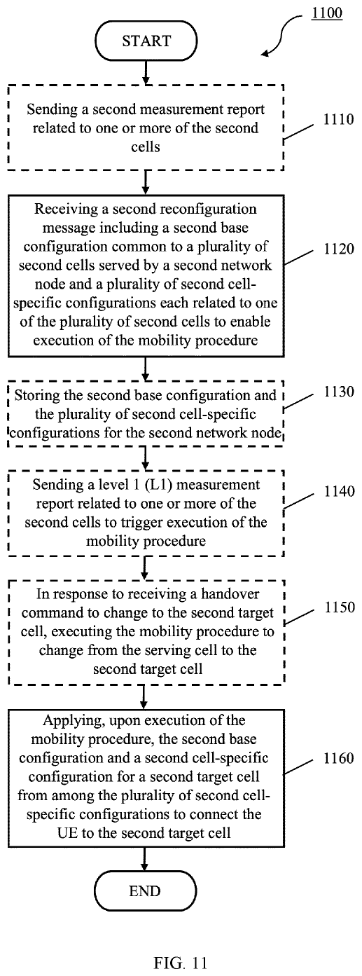

FIG. 11 illustrates a flow chart of a method for efficient configuration of L1/L2 mobility according to some other example embodiments. The method 1100 is performed by a user equipment (UE) or by an apparatus in the UE. For example, the UE may be represented by any one of the user devices 131, 132, 133 as described above with reference to FIG. 1, mobile communication devices 202, 204, 205 of the wireless communication system 200 as described above with reference to FIG. 2, the communication device 430 as described above with reference to FIG. 4, or the communication device 500 as described above with reference to FIG. 5. More generally, the UE may be represented by any of the communication device described herein.

Similar to FIG. 10, the UE is connected to a network. That is, the UE is connected to a serving cell served by a network node (i.e., a first network node) of the network. That is, the UE may have performed a connection procedure (e.g., a RRC connection procedure) and established a session (e.g., a PDU session) to connect the UE to the serving cell. However, contrary to the method 1000 of FIG. 10, the UE may not only change from the serving cell to the target cell both served by the first network node but may also be handed over to another network node (referred to as second network node) and connect to a target cell served by the second network node. The second network node may comprise another base station gNB of the network, another distributed unit DU of the base station gNB of the network in the disaggregated gNB architecture (i.e., the base station gNB of the first network node), or a master/secondary node MN/SN in the dual connectivity scenario, serving a plurality of second cells (i.e., one or more second cells).

At block 1120, similar to block 1020 of FIG. 10, the UE receives a reconfiguration message (e.g., a RRC Reconfiguration message) from the first network node. The reconfiguration message is to enable execution of a mobility procedure (e.g., a L1/L2 mobility procedure) to change from the serving cell to another cell. However, the reconfiguration message received at block 1120 comprises a base configuration and a plurality of cell-specific configurations for the second network node. The base configuration for the second network node comprises a configuration (e.g., a set of configuration parameters) common to the plurality of second cells served by the second network node, or a set of second cells among the plurality of second cells. In some examples, the base configuration received at block 1120 may also be common to the plurality of first cells served by the first network node. That is, in such examples, the first and second networks nodes share a common base configuration. Each cell-specific configuration comprises a configuration (e.g., a set of configuration parameters) specific to a cell among the plurality of second cells, or the set of second cells among the plurality of second cells. That is, each cell-specific configuration relates to one of the plurality of second cells. In combination, the base configuration and the cell-specific configuration for a cell of the second network node represent a configuration (i.e., a full configuration) required by the UE to connect to the cell. In some examples, the cell-specific configuration may be a delta configuration (i.e., delta to the base configuration).

Examples of the reconfiguration message received at block 1120 may comprise one or more PreparedCellConfig information elements as described above. Further details regarding the reconfiguration message will be provided hereinbelow.

At block 1160, the UE applies a cell-specific configuration for a target cell, from among the plurality of cell-specific configurations received with the reconfiguration message at block 1120. The target cell is a cell among the plurality of second cells served by the second network node. The UE applies the cell-specific configuration for the target cell upon execution of the mobility procedure to connect the UE to the target cell. That is, the UE is to switch from the first network node to the second network node and change connection from the serving cell of the first network node to the target cell of the second network node (i.e., the UE is handed over to the target cell of the second network node). As a result of block 1160, the UE is connected to the target cell within the second network node.

In some examples, the UE uses a set of parameters according to the cell-specific configuration and applies the set of parameters to the common base configuration used by the UE to form a full configuration required to connect to the target cell of the second network node (i.e., the UE applies the delta configuration according to the cell-specific configuration to the common base configuration). Before doing so, the UE may determine that the base configuration used by the UE for the first network node (i.e., the base configuration used by the UE to connect to the serving cell of the first network node) corresponds to the base configuration received at block 1120. That is, the set of parameters according to the common base configuration used by the UE corresponds to the set of parameters according to the base configuration received at block 1120. The UE may perform a comparison of the base configurations as described above. So, in case of the common base configuration, the UE replaces at least part of the cell-specific configuration used to connect to the serving cell of the first network node by the cell-specific configuration for the target cell of the second network node, while maintaining the common base configuration used by the UE.

In some examples, the UE may apply the base configuration and the cell-specific configuration received at block 1120. That is, the UE replaces at least part of the base configuration used to connect to the first network node by the base configuration received at block 1120, and the cell-specific configuration for the serving cell by the cell-specific configuration for the target cell.

In some examples, the UE sends a measurement report to the first network node at block 1110. Similar to block 1010 of FIG. 10, the measurement report may contain cell quality measurements related to cells. More specifically, the cell quality measurements relate to second cells served by the second network node. Based on the cell quality measurements of the measurement report, the first network node can decide that the UE is on a border of the first network node (i.e., a coverage by the cells of the first network node) and is to be handed over to the second network node. The first network node can prepare the reconfiguration message to be sent to the UE as will be described in more detail hereinbelow. In response to sending the measurement report, the UE may receive the reconfiguration message from the first network node at block 1120.

In some other examples, at block 1130, the UE may store the base configuration and the plurality of cell-specific configurations received from the first network node at block 1120. For example, the UE may store the base configuration and the plurality of cell-specific configurations for the second network node in the memory. That is, if the UE previously received a base configuration and a plurality of cell-specific configurations for the first network node, the UE may add the base configuration and the plurality of cell-specific configurations for the second network node to the memory. However, in response to determining based on a comparison as described above that the common base configuration was received with a previous reconfiguration message and is stored, the UE may store the plurality of cell-specific configurations for the second network node only.

In some examples, at block 1140, the UE may send a measurement report related to one or more of the second cells to the first network node. The measurement report may be a layer 1 (L1) measurement report as described above. Based on the L1 measurement report, the first network node decides whether to switch to the second network node and change the UE to the target cell of the second network node (i.e., one cell among the second cells served by the second network node or one cell among the potential set of candidate target cells). The execution of the mobility procedure to switch to the second network node and change to the target cell of the second network node is triggered in response to the UE receiving a handover command from the first network node at block 1150. Thus, in response to receiving the handover command, the UE applies the base configuration for the second network node and the cell-specific configuration for the target cell of the second network node at block 1160 to switch to the second network node and connect to the target cell of the second network node. The connection to the target cell may be established by the UE by performing a random-access procedure with the second network node.

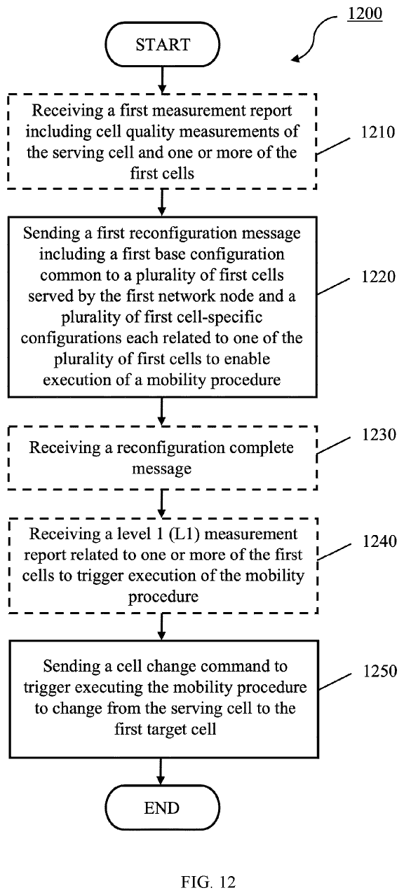

FIG. 12 illustrates a flow chart of a method for efficient configuration of L1/L2 mobility according to some example embodiments. The method 1200 is performed by a network and more specifically, by a network node of the network. The network node (referred to as first network node) such as a base station gNB, a distributed unit DU of a base station gNB in a disaggregated gNB architecture, a master/secondary node MN/SN in a dual connectivity scenario, etc.) serves a plurality of first cells (i.e., one or more first cells). As it will be understood by one of ordinary skill, in the disaggregated gNB architecture, the method may be performed by a distributed unit DU of the base station gNB or a central unit CU of the base station gNB. The network node may comprise, or is represented by, the control apparatus 600 as described above with reference to FIG. 6 or an apparatus.

The first network node serves a plurality of first cells (i.e., one or more first cells). A user equipment (UE) may be connected to the network. For example, the UE may be connected to a cell (i.e., a serving cell) served by the first network node. To connect the UE to the serving cell, the UE may have performed a connection procedure (e.g., a RRC connection procedure) and established a session (e.g., a PDU session).

At block 1220, the first network node sends a reconfiguration message to the UE. The reconfiguration message (e.g., a RRC Reconfiguration message) is to enable execution of a mobility procedure (e.g., a L1/L2 mobility procedure) to change from the serving cell to another cell. The reconfiguration message comprises a base configuration and a plurality of cell-specific configurations. The base configuration comprises a configuration (e.g., a set of configuration parameters) common to the plurality of first cells served by the first network node, or a set of first cells among the plurality of first cells. Each cell-specific configuration comprises a configuration (e.g., a set of configuration parameters) specific to a cell among the plurality of first cells, or the set of first cells among the plurality of first cells. That is, each cell-specific configuration relates to one of the plurality of first cells (i.e., the cell).

In some examples, the base configuration and the plurality of cell-specific configurations may be prepared by the first network node. For example, the first network node may use configurations (i.e., full configurations) including a full set of parameters for the plurality of first cells, or the set of first cells among the plurality of first cells and determines a subset of parameter from among the full set of parameters that is common to the plurality of first cells, or the set of first cells among the plurality of first cells. The first network device may use the determined subset of parameters to prepare the base configuration for the first network node. Using the base configuration, the first network device may determine, for each cell among the plurality of first cells, or the set of first cells among the plurality of first cells, a delta to the full set of parameters (i.e., a delta configuration). The base configuration for the first base configuration and the delta configuration for a cell in combination form the full configuration for that cell in the first base station. The full configuration for the cell represents a configuration required by the UE to connect to the cell.

Examples of the reconfiguration message sent at block 1220 may comprise one or more PreparedCellConfig information elements as described above. Further details regarding the reconfiguration message will be provided hereinbelow.

At block 1250, the first network node may send a cell change command to the UE to trigger execution of the mobility procedure. The execution of the mobility procedure causes the UE to apply at least a cell-specific configuration for a target cell from among the plurality of cell-specific configurations sent to the UE at block 1220 to change the UE from the serving cell and connect the UE to the target cell. The connection to the target cell may be established by the UE by performing a random-access procedure with the first network node.

In some examples, the first network device may receive a measurement report from the UE at block 1210. The measurement report may contain cell quality measurements related to cells. The cells may include the serving cell and one or more neighboring cells such as cells of the plurality of first cells served by the first network node. Based on the cell quality measurements of the measurement report, the first network node can identify a potential set of candidate target cells to which the UE can change connection and prepare the reconfiguration message. In response to receiving the measurement report, the first network node may send the reconfiguration message to the UE.

In some examples, an acknowledgement of reception of the reconfiguration message may be received by the first network node from the UE, at block 1230. For example, the first network node may receive a reconfiguration complete message (e.g., a RRC Reconfiguration Complete message) from the UE, indicating to the first network node that the base configuration and the plurality of cell-specific configurations have been received by (and stored at) the UE and are ready for use. At block 1240, the first network node may receive a measurement report related to one or more of the first cells from the UE. The measurement report may be a layer 1 (L1) measurement report. Based on the L1 measurement report, the first network node decides whether to change the UE from the serving cell to the target cell (i.e., one cell among the first cells served by the first network node or one cell among the potential set of candidate target cells). Thus, the first network node decides, based on the L1 measurement report, whether to trigger, at the UE, execution of the mobility procedure to change from the serving cell to the target cell. If decided, the first network node sends the cell change command to the UE to trigger execution of the mobility procedure.

Further, in some examples, the network may comprise another network node (referred to as a second network node) serving a plurality of second cells. The UE may also be handed over to the other network node and connect to a target cell served by the second network node. The second network node may comprise another base station gNB of the network, another distributed unit DU of the base station gNB of the network in the disaggregated gNB architecture (i.e., the base station gNB of the first network node), or a master/secondary node MN/SN in the dual connectivity scenario.

To hand over the UE to the second network node, the first network node may send a reconfiguration message including a base configuration common to the plurality of second cells and a plurality of cell-specific configurations to the UE. Each of the cell-specific configurations is related to one of the plurality of second cells. The reconfiguration message is to enable execution of the mobility procedure for handing over to the second network node.

The base configuration and the plurality of cell-specific configurations for the second network node may be received from the second network node or prepared by the first network node based on information received from the second network node, as will be described hereinbelow.

The base configuration for the second network node comprises a configuration (e.g., a set of configuration parameters) common to the plurality of second cells served by the second network node, or a set of second cells among the plurality of second cells. In some examples, the base configuration for the second network node may also be common to the plurality of first cells served by the first network node. That is, in such examples, the first and second networks nodes share a common base configuration. Each cell-specific configuration comprises a configuration (e.g., a set of configuration parameters) specific to a cell among the plurality of second cells, or the set of second cells among the plurality of second cells. That is, each cell-specific configuration relates to one of the plurality of second cells. In combination, the base configuration and the cell-specific configuration for a cell of the second network node represent a configuration (i.e., a full configuration) required by the UE to connect to the cell. In some examples, the cell-specific configuration may be a delta configuration (i.e., delta to the base configuration).

Examples of the reconfiguration message may comprise one or more PreparedCellConfig information elements as described above. Further details regarding the reconfiguration message will be provided hereinbelow.

The execution of the mobility procedure to switch to the second network node and change to a target cell of the second network node may be triggered by the first network node sending a handover command to the UE. In response to the handover command, the UE applies the base configuration for the second network node and the cell-specific configuration for the target cell of the second network node to switch to the second network node and connect to the target cell of the second network node. The connection to the target cell may be established by the UE by performing a random-access procedure with the second network node.

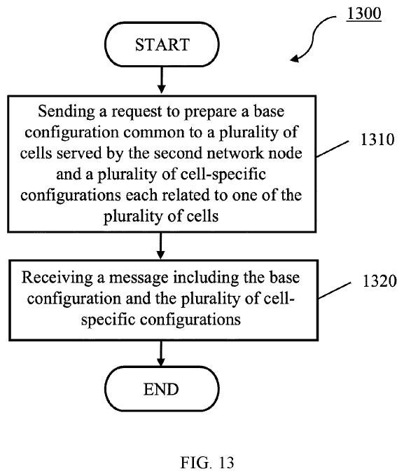

FIG. 13 illustrates a flow chart of a method for efficient configuration of L1/L2 mobility according to some example embodiments. The method 1300 is performed by a network and more specifically, by a network node of the network. The network node (referred to as first network node) such as a base station gNB, a distributed unit DU of a base station gNB in a disaggregated gNB architecture, a master/secondary node MN/SN in a dual connectivity scenario, etc.) serves a plurality of first cells (i.e., one or more first cells). As it will be understood by one of ordinary skill, in the disaggregated gNB architecture, the method may be performed by a distributed unit DU of the base station gNB or a central unit CU of the base station gNB. The network node may comprise, or is represented by, the control apparatus 600 as described above with reference to FIG. 6 or an apparatus.

The first network node serves a plurality of first cells (i.e., one or more first cells). A user equipment (UE) may be connected to the network. For example, the UE may be connected to a cell (i.e., a serving cell) served by the first network node. To connect the UE to the serving cell, the UE may have performed a connection procedure (e.g., a RRC connection procedure) and established a session (e.g., a PDU session).

The network may comprise another network node (referred to as a second network node) serving a plurality of second cells. The second network node may comprise another base station gNB of the network, another distributed unit DU of the base station gNB of the network in the disaggregated gNB architecture (i.e., the base station gNB of the first network node), or a master/secondary node MN/SN in the dual connectivity scenario.

In handing over the UE from the first network node to the second network node, the first network node may request the second network node to prepare a base configuration common to a plurality of cells served by the second network node and a plurality of cell-specific configurations each related to one of the plurality of second cells, at block 1310. For example, the first network node may send a handover request to the second network node.

At block 1320, the first network node may receive a message including the base configuration and the plurality of cell-specific configurations from the second network node. The message received by the first network node may comprise a request acknowledgement message such as a handover request acknowledgement message.

In some examples, the base configuration and the plurality of cell-specific configurations may be prepared by the second network node. For example, the second network node may use configurations (i.e., full configurations) including a full set of parameters for the plurality of second cells, or the set of second cells among the plurality of second cells and determines a subset of parameter from among the full set of parameters that is common to the plurality of second cells, or the set of second cells among the plurality of second cells. The second network device may use the determined subset of parameters to prepare the base configuration for the second network node. Using the base configuration, the second network device may determine, for each cell among the plurality of second cells, or the set of second cells among the plurality of second cells, a delta to the full set of parameters (i.e., a delta configuration). The base configuration for the second network node and the delta configuration for a cell served by the second network node combine to the full configuration for that cell in the second base station. The full configuration for the cell represents a configuration required by the UE to connect to the cell.

In some examples, the first network node may request the second network node at block 1310 in response to receiving a measurement report related to one or more of the second cells served by the second network node. As described above, the first network node may send, to the UE, a reconfiguration message including the base configuration for the second network node and the plurality of cell-specific configurations related to the plurality of second cells, and a handover command to trigger execution of the mobility procedure. The mobility procedure is to hand over the UE to the second network node and connect to the target cell in the second network node.

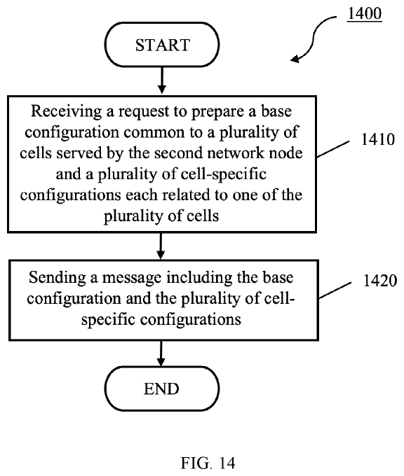

FIG. 14 illustrates a flow chart of a method for efficient configuration of L1/L2 mobility according to some example embodiments. The method 1400 is performed by a network and more specifically, by a network node of the network. The network node (referred to as second network node) such as a base station gNB, a distributed unit DU of a base station gNB in a disaggregated gNB architecture, a master/secondary node MN/SN in a dual connectivity scenario, etc.) serves a plurality of second cells (i.e., one or more second cells). As it will be understood by one of ordinary skill, in the disaggregated gNB architecture, the method may be performed by a distributed unit DU of the base station gNB or a central unit CU of the base station gNB. The network node may comprise, or is represented by, the control apparatus 600 as described above with reference to FIG. 6 or an apparatus.

The network may comprise another network node (referred to as a first network node) serving a plurality of first cells. The first network node may comprise another base station gNB of the network, another distributed unit DU of the base station gNB of the network in the disaggregated gNB architecture (i.e., the base station gNB of the second network node), or a master/secondary node MN/SN in the dual connectivity scenario. The first network node serves a plurality of first cells (i.e., one or more first cells).

A user equipment (UE) may be connected to the network. For example, the UE may be connected to a cell (i.e., a serving cell) served by the first network node. To connect the UE to the serving cell, the UE may have performed a connection procedure (e.g., a RRC connection procedure) and established a session (e.g., a PDU session).

In handing over the UE from the first network node to the second network node, the second network node may receive a request to prepare a base configuration common to a plurality of cells served by the second network node and a plurality of cell-specific configurations each related to one of the plurality of second cells from the first network node, at block 1410. For example, the second network node may receive a handover request from the first network node.

At block 1420, the second network node may send a message including the base configuration and the plurality of cell-specific configurations to the first network node. The message sent to the first network node may comprise a request acknowledgement message such as a handover request acknowledgement message.

In some examples, the base configuration and the plurality of cell-specific configurations may be prepared by the second network node as described above.

In some examples, the second network node may allocate the base configuration and the plurality of cell-specific configurations for the plurality of second cells.

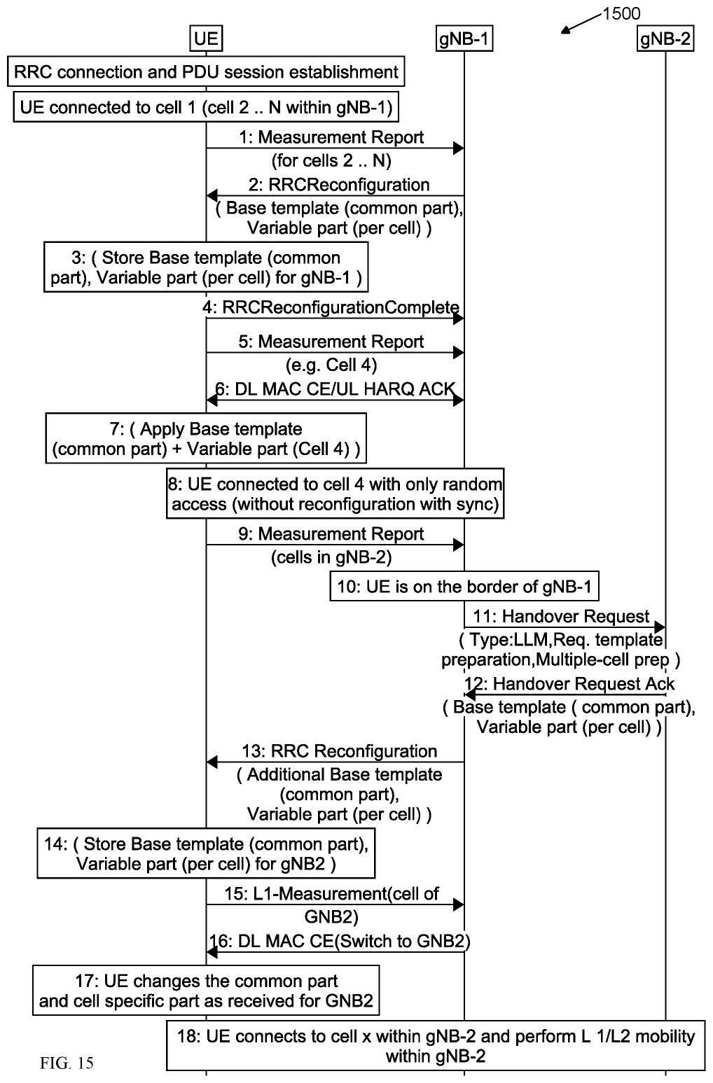

FIG. 15 is an exemplary sequence diagram illustrating an optimized intra-gNB and inter-gNB L1/L2 mobility signalling 1500, according to some example embodiments.

The intra-gNB and inter-gNB L1/L2 mobility signalling may be implemented in a network such as a 5G network, including one or more network nodes such as the base station 420 shown in FIG. 4 (e.g., first base station gNB-1 and second base station g-NB2) and a mobile device such as the UE 430 shown in FIG. 4 (e.g., UE). Each of the base stations gNB-1 and g-NB2 serves a plurality of cells (referred to as a plurality of first cells served by the first base station gNB-1 and a plurality of second cells served by the second base station gNB-2) such as Cell1 401 to Cell6 406 and Cell8 408 served by the base station 420 shown in FIG. 4.

The UE is connected to a cell (e.g., cell 1) among the plurality of first cells (e.g., cells 1 . . . . N) served by the first base station gNB-1. As it will be understood by one of ordinary skill, the UE is connected to the cell by performing RRC connection procedure and establishing a PDU session. That is, in FIG. 15, the UE is assumed to be RRC connected to cell 1 with PDU session established.

Signaling steps for intra-gNB L1/L2 mobility shown in FIG. 15 will now be described.

Starting at step 1, the UE may send a measurement report to the first base station gNB-1. The measurement report may include cell quality measurements with respect to the serving cell (i.e., cell 1) and one or more of the first cells (i.e., cells 2 . . . . N) served by the first base station gNB-1.

At step 2, the first base station gNB-1 sends a reconfiguration message (e.g., a RRC Reconfiguration message). For example, the reconfiguration message may be sent in response to receiving, at the first base station gNB-1, the measurement report from the UE. The reconfiguration message includes a base configuration and a plurality of cell-specific configurations. The base configuration (also referred to as base template or common part) is common to the plurality of first cells served by the first base station gNB-1. For example, the base configuration comprises common configuration parameters of the plurality of first cells. Each of the plurality of cell-specific configurations (also referred to as variable part per cell) relates to one of the plurality of first cells. For example, a cell-specific configuration for cell 1 comprises configuration parameters specific to the cell 1. That is, the combination of the base configuration and the cell-specific configuration for a particular cell among the first cells forms the configuration for the particular cell, including the configuration parameters for that particular cell (e.g., configuration parameter necessary for the UE to establish a connection to the particular cell). The reconfiguration message is to enable execution of the mobility procedure (e.g., intra-gNB L1/L2 mobility) by the UE to change from cell 1 to another cell served by the first base station gNB-1.

At step 3, the UE may store the base configuration (i.e., the base template) and the plurality of cell-specific configurations (i.e., the variable part per cell) for the first base station gNB-1. For example, the base configuration and the plurality of cell-specific configurations may be stored in a memory of the UE for intra-gNB L1/L2 mobility. If the UE already comprises a stored base configuration for the first base station gNB-1, which was received previously (e.g., received with a previous reconfiguration message), the UE may replace at least part of the stored base configuration by the base configuration received at step 2.

At step 4, the UE may acknowledge reception of the reconfiguration message (i.e., the base configuration and the plurality of cell-specific configurations) to the first base station gNB-1. For example, the UE may send a reconfiguration complete message (e.g., a RRC Reconfiguration Complete message) to the first base station gNB-1. The reconfiguration complete message indicates to the first base station gNB-1 that the base configuration and the plurality of cell-specific configurations is received and can be used by the UE for intra-gNB L1/L2 mobility.

At step 5, the UE may send a measurement report to the first base station gNB-1. The measurement report may be a L1 measurement report related to one or more of the first cells. For example, the UE may report an L1 Reference Signal Received Power (RSRP) measurement to the first base station gNB-1. In response to receiving the measurement report, the first base station gNB-1 may decide that the UE is to change from the serving cell 1 to another cell (e.g., cell 4) served by the first base station gNB-1. The first base station gNB-1 may initiate the mobility (i.e., the intra-gNB L1/L2 mobility) towards cell 4 as target cell using a Medium Access Control (MAC) Control Element (CE) sent to the UE at step 6. The UE may send, also at step 6, Hybrid Automatic Repeat Request (HARQ) Acknowledgement (ACK) to the first base station gNB-1 in response to the MAC CE. That is, the first base station gNB-1 may send a cell change command to change to the target cell to the UE. The cell change command is to trigger execution of the mobility procedure (i.e., the intra-gNB L1/L2 mobility) to change to the target cell (e.g., cell 4).

At step 7, the UE loads the base configuration for the first base station gNB-1 and applies the cell-specific configuration for the target cell (i.e., cell 4). That is, the UE uses the cell-specific configuration for the target cell received from the first base station gNB-1 at step 2 and stored at step 3. In some examples, the UE may determine whether the base configuration currently applied for the first base station gNB-1 and the base configuration received from the first base station gNB-1 at step 2 and stored at step 3 are different. That is, the UE may determine whether the base configuration for the first base station gNB-1 has changed since applying the base configuration to connect to cell 1 (i.e., whether one or more configuration parameters of the base configuration have changed). If the base configurations differ, the UE applies the base configuration and the cell-specific configuration for the target cell, both stored at step 3. In some examples, the UE may combine the base configuration and the cell-specific configuration to form a full configuration for the target cell in the first base station gNB-1 and apply the full configuration. In other examples, the UE may first apply the base configuration for the first base station gNB-1 and then apply the cell-specific configuration for the target cell. Otherwise, if the base configurations do not differ, the UE may apply the cell-specific configuration for the target cell (i.e., cell 4) to the base configuration currently applied, thereby replacing the cell-specific configuration for the serving cell (i.e., cell 1). That is, the UE may load the base configuration currently applied and apply the cell-specific configuration for the target cell to the base configuration currently applied.

At step 8, the UE executes the mobility procedure (i.e., the intra-gNB L1/L2 mobility) and performs connection establishment to the target cell (i.e., cell 4). For example, the UE may perform only random-access procedure to connect to the target cell. A reconfiguration with synchronization does not need to be performed. Thereby, the UE changes from the serving cell (i.e., cell 1) to the target cell (i.e., cell 4) both served by the first base station gNB-1.

FIG. 15 also illustrates signaling steps for inter-gNB L1/L2 mobility which will now be described.

As already discussed above, the UE is assumed to be RRC connected to a cell served by the first base station gNB-1 (e.g., cell 1 or due to the intra-gNB L1/L2 mobility cell 4) with PDU session established.

At step 9, the UE may send a measurement report to the first base station gNB-1. For example, in case the UE is at the border of the first base station gNB-1 and the second base station gNB-2 and thus may be connected to a cell served by the second base station gNB-2, the UE may send the measurement report related to one or more of the second cells served by the second base station gNB-2.

In response to receiving the measurement report at step 9, the first base station gNB-1 may determine, at step 10, that the UE is at the border of the first base station gNB-1 and the second base station gNB-2 and that a handover to the second base station gNB-2 may be initiated.

At step 11, the first base station gNB-1 may initiate the handover and send a handover request to the second base station gNB-2. The handover request may be of type LLM and indicates to prepare the base configuration and cell-specific configurations for the second cells to the second base station gNB-2. That is, the second base station gNB-2 is requested by the handover request to prepare the handover configuration including L1/L2 mobility using the base configuration and cell-specific configurations. In response to the handover request, the second base station gNB-2 may prepare the base configuration common to the plurality of second cells served by the second base station gNB-2 and a plurality of cell-specific configurations for the plurality of second cells.

At step 12, the second base station gNB-2 may send an acknowledgment to the first base station gNB-1. For example, the second base station gNB-2 may send a handover request acknowledgement. The handover request acknowledgement includes the base configuration for the second base station gNB-2 and the plurality of cell-specific configurations for the plurality of second cells.

At step 13, the first base station gNB-1 sends a reconfiguration message (e.g., RRC Reconfiguration message) to the UE. The reconfiguration message includes the base configuration for the second base station gNB-2 and the plurality of cell-specific configurations for the plurality of second cells served by the second base station gNB-2. The reconfiguration message is to enable execution of the mobility procedure (e.g., inter-gNB L1/L2 mobility) by the UE to change from cell 1 (or cell 4) of the first base station gNB-1 to a cell served by the second base station gNB-2.

At step 14, the UE may store the base configuration (i.e., the base template) and the plurality of cell-specific configurations (i.e., the variable part per cell) for the second base station gNB-2. For example, the base configuration and the plurality of cell-specific configurations may be stored in the memory of the UE for inter-gNB L1/L2 mobility. That is, the UE may store sets of base configuration and cell-specific configurations for different base stations. If the UE already comprises a stored base configuration for the second base station gNB-2, which was received previously (e.g., received with a previous reconfiguration message), the UE may replace at least part of the stored base configuration by the base configuration received at step 13.

At step 15, the UE may send a measurement report to the first base station gNB-1. The measurement report may be a L1 measurement report related to one or more of the second cells served by the second base station gNB-2. For example, the UE may report an L1 RSRP measurement to the first base station gNB-1.

In response to receiving the measurement report, the first base station gNB-1 may decide that the UE is to switch from the first base station gNB-1 to the second base station gNB-2 (i.e., handover is to be performed). The first base station gNB-1 may initiate the mobility (i.e., the inter-gNB L1/L2 mobility) towards the second base station gNB-2 using a MAC CE. The UE may send HARQ ACK to the first base station gNB-1 in response to the MAC CE. That is, the first base station gNB-1 may send a handover command at step 16 to switch to the second base station gNB-2 and change to a target cell served by the second base station gNB-2.

At step 17, the UE changes the base configuration and the cell-specific configuration for the target cell using the base configuration for the second base station and the cell-specific configuration for the target cell. That is, the UE uses the base configuration for the second base station and the cell-specific configuration for the target cell both received from the first base station gNB-1 at step 13 and stored at step 14. In some examples, the UE may combine the base configuration for the second base station gNB-2 and the cell-specific configuration for the target cell to form a full configuration for the target cell in the second base station gNB-2 and apply the full configuration. In other examples, the UE may first apply the base configuration for the second base station gNB-2 and then apply the cell-specific configuration for the target cell. Otherwise, in case the base configuration for the second base station gNB-2 is also common to the plurality of first cells served by the first base station gNB-1, the UE may apply the cell-specific configuration for the target cell to the base configuration currently applied, thereby replacing the cell-specific configuration for the serving cell (i.e., cell 1 of the first base station gNB-1). That is, the UE applies the base configuration for the second base station gNB-2 and the cell-specific configuration for the target cell served by the second base station gNB-2 to switch the UE to the second base station gNB-2 and connect the UE to the target cell of the second base station gNB-2.

At step 18, the UE executes the mobility procedure (i.e., the inter-gNB L1/L2 mobility) and performs connection establishment to the target cell of the second base station gNB-2. Thereby, the UE switches to the second base station gNB-2 and connects to a cell of the second base station gNB-2.

Further details regarding the reconfiguration message received at steps 2 and 13 of FIG. 15 will be provided hereinbelow.

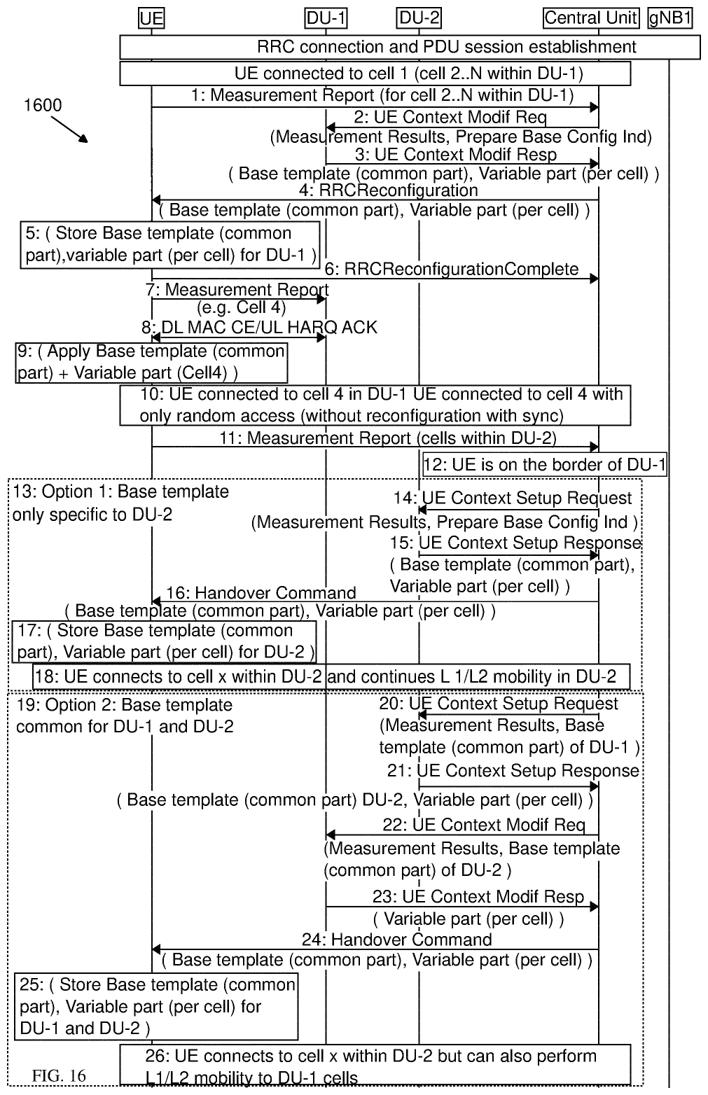

FIG. 16 is an exemplary sequence diagram illustrating an optimized intra-gNB L1/L2 mobility intra-DU and inter-DU case signaling 1600 according to some example embodiments.

The intra-gNB L1/L2 mobility intra-DU and inter-DU case signaling may be implemented in a network such as a 5G network. More specifically, the intra-gNB L1/L2 mobility intra-DU and inter-DU case signaling may be implemented in a network using the disaggregated gNB architecture shown in FIG. 3. That is, the network includes one or more network nodes such as base stations (e.g., the base station 420 shown in FIG. 4) decomposed into multiple logical entities. For example, the network includes a base station gNB1 decomposed into a central unit (also referred to as gNB-CU or CU) and multiple distributed units (referred to as gNB-DUs or DUs) including a first distributed unit (referred to as DU-1) and a second distributed unit (referred to as DU-2). The network also includes a mobile device such as the UE 430 shown in FIG. 4 (e.g., UE). The base station gNB1 serves a plurality of cells (referred to as a plurality of cells served by the base station gNB1) such as Cell1 401 to Cell6 406 and Cell8 408 served by the base station 420 shown in FIG. 4. In the disaggregated gNB architecture, the first distributed unit DU-1 of the base station gNB1 serves a plurality of first cells of the plurality of cells served by the base station gNB1, and the second distributed unit DU-2 of the base station gNB1 serves a plurality of second cells of the plurality of cells served by the base station gNB1. The central unit of the base station gNB1 controls operations of the distributed units.

According to the general principles of the subject disclosure, for preparing intra-gNB intra-DU L1/L2 mobility for a given UE, the central unit CU negotiates a base configuration (i.e., a base template) specific for a distributed unit DU and requests preparation for a given set of cells within the distributed unit DU. The distributed DU prepares the base configuration and a set of cell-specific configuration container for each prepared cell.

According to the general principles of the subject disclosure, for preparing intra-gNB inter-DU L1/L2 mobility for a given UE across more than one distributed unit DU, the central unit CU negotiates a common base configuration across the distributed unit(s) DU(s). Each distributed unit DU prepares a set of cell-specific configuration container for each prepared cell.

According to the general principles of the subject disclosure, the UE stores the base configuration, the cell-specific configuration container for each prepared cell including serving cell. Thereby, the UE knows the cell-specific part of the current configuration based on the base configuration. Upon reception of MAC CE for L1/L2 mobility, the UE moving to a given cell loads the base configuration if the base configuration is different for the target cell and applies the cell-specific configuration container for that target cell. In case of mobility to the target cell having same base configuration template, the UE only changes the cell-specific part of current configuration to the target cell-specific configuration. The cell-specific part of serving cell is stored along with other cells for which the configurations are stored. When the UE moves back to same serving cell the UE apply the cell-specific part from stored configuration and resume the connection. Here the UE mobility back to serving cell or any cell is managed with replacing cell-specific configuration without applying full configuration.

The UE is connected to a cell (e.g., cell 1) among the plurality of first cells (e.g., cells 1 . . . . N) served by the first distributed unit DU-1. As it will be understood by one of ordinary skill, the UE is connected to the cell by performing RRC connection procedure and establishing a PDU session. That is, in FIG. 16, the UE is assumed to be RRC connected to cell 1 with PDU session established.

Signaling steps for intra-gNB intra-DU L1/L2 mobility shown in FIG. 16 will now be described.

Starting at step 1, the UE may send a measurement report to the central unit of the base station gNB1. The measurement report may include cell quality measurements with respect to the serving cell (i.e., cell 1) and one or more of the first cells (i.e., cells 2 . . . . N) served by the first distributed unit DU-1.

At step 2, the central unit sends a modification request (e.g., UE Context Modification Request message or UE Context Modif Request message) to prepare a base configuration to the first distributed unit DU-1. The modification request may include an indication to prepare the base configuration to the first distributed unit DU-1. The modification request may further include cell quality measurements, or measurement results, received from the UE at step 1. That is, the first distributed unit DU-1 is requested by the modification request to prepare the base configuration for intra-gNB intra-DU L1/L2 mobility. In response to the modification request, the first distributed unit DU-1 may prepare the base configuration (i.e., a base template or common part) common to the plurality of first cells served by the first distributed unit DU-1 and a plurality of cell-specific configurations (i.e., a variable part per cell) for the plurality of first cells. For example, the base configuration comprises common configuration parameters of the plurality of first cells. Each of the plurality of cell-specific configurations relates to one of the plurality of first cells. For example, a cell-specific configuration for cell 1 comprises configuration parameters specific to the cell 1. That is, the combination of the base configuration and the cell-specific configuration for a particular cell among the first cells forms the configuration for the particular cell, including the configuration parameters for that particular cell (e.g., configuration parameter necessary for the UE to establish a connection to the particular cell).

At step 3, the first distributed unit DU-1 provides the base configuration and the plurality of cell-specific configurations to the central unit. For example, the first distributed unit DU-1 sends a modification response (e.g., UE Context Modification Response message or UE Context Modif Response message) to the central unit. The modification response includes the base configuration and the plurality of cell-specific configurations.

At step 4, the central unit sends a reconfiguration message (e.g., a RRC Reconfiguration message) to the UE. The reconfiguration message includes the base configuration for the first distributed unit DU-1 and the plurality of cell-specific configurations for the plurality of first cells served by the first distributed unit DU-1. The reconfiguration message is to enable execution of the mobility procedure (e.g., intra-gNB intra-DU L1/L2 mobility) by the UE to change from cell 1 to another cell served by the first distributed unit DU-1.

At step 5, the UE may store the base configuration (i.e., the base template) and the plurality of cell-specific configurations (i.e., the variable part per cell) for the first distributed unit DU-1. For example, the base configuration and the plurality of cell-specific configurations may be stored in a memory of the UE for intra-gNB intra-DU L1/L2 mobility. If the UE already comprises a stored base configuration for the first distributed unit DU-1, which was received previously (e.g., received with a previous reconfiguration message), the UE may replace at least part of the stored base configuration by the base configuration received at step 4.

At step 6, the UE may acknowledge reception of the reconfiguration message (i.e., the base configuration and the plurality of cell-specific configurations) to the central unit. For example, the UE may send a reconfiguration complete message (e.g., a RRC Reconfiguration Complete message) to the central unit. The reconfiguration complete message indicates to the central unit that the base configuration and the plurality of cell-specific configurations is received and can be used by the UE for intra-gNB intra-DU L1/L2 mobility.

At step 7, the UE may send a measurement report to the first distributed unit DU-1. The measurement report may be a L1 measurement report related to one or more of the first cells. For example, the UE may report an L1 Reference Signal Received Power (RSRP) measurement to the first distributed unit DU-1. In response to receiving the measurement report, the first distributed unit DU-1 may decide that the UE is to change from the serving cell 1 to another cell (e.g., cell 4) served by the first distributed unit DU-1. The first distributed unit DU-1 may initiate the mobility (i.e., the intra-gNB intra-DU L1/L2 mobility) towards cell 4 as target cell using a Medium Access Control (MAC) Control Element (CE) sent to the UE at step 8. The UE may send, also at step 8, Hybrid Automatic Repeat Request (HARQ) Acknowledgement (ACK) to the first distributed unit DU-1 in response to the MAC CE. That is, the first distributed unit DU-1 may send a cell change command to change to the target cell to the UE. The cell change command is to trigger execution of the mobility procedure (i.e., intra-gNB intra-DU L1/L2 mobility) to change to the target cell (e.g., cell 4).

At step 9, the UE loads the base configuration for the first distributed unit DU-1 and applies the cell-specific configuration for the target cell (i.e., cell 4). That is, the UE uses the cell-specific configuration for the target cell received from the first distributed unit DU-1 at step 4 and stored at step 5. In some examples, the UE may determine whether the base configuration currently applied for the first distributed unit DU-1 and the base configuration received from the central unit at step 4 and stored at step 5 are different. That is, the UE may determine whether the base configuration for the first distributed unit DU-1 has changed since applying the base configuration to connect to cell 1 (i.e., whether one or more configuration parameters of the base configuration have changed). If the base configurations differ, the UE applies the base configuration and the cell-specific configuration for the target cell, both stored at step 5. In some examples, the UE may combine the base configuration and the cell-specific configuration to form a full configuration for the target cell in the first distributed unit DU-1 and apply the full configuration. In other examples, the UE may first apply the base configuration for the first distributed unit DU-1 and then apply the cell-specific configuration for the target cell. Otherwise, if the base configurations do not differ, the UE may apply the cell-specific configuration for the target cell (i.e., cell 4) to the base configuration currently applied, thereby replacing the cell-specific configuration for the serving cell (i.e., cell 1). That is, the UE may load the base configuration currently applied and apply the cell-specific configuration for the target cell to the base configuration currently applied.

At step 10, the UE executes the mobility procedure (i.e., the intra-gNB intra-DU L1/L2 mobility) and performs connection establishment to the target cell (i.e., cell 4). For example, the UE may perform only random-access procedure to connect to the target cell. A reconfiguration with synchronization does not need to be performed. Thereby, the UE changes from the serving cell (i.e., cell 1) to the target cell (i.e., cell 4) both served by the first distributed unit DU-1.

FIG. 16 also illustrates signaling steps for intra-gNB inter-DU L1/L2 mobility which will now be described.

As already discussed above, the UE is assumed to be RRC connected to a cell served by the first distributed unit DU-1 (e.g., cell 1 or due to the intra-gNB intra-DU L1/L2 mobility cell 4) with PDU session established.

At step 11, the UE may send a measurement report to the central unit. For example, in case the UE is at the border of the first distributed unit DU-1 and the second distributed unit DU-2 and thus may be connected to a cell served by the second distributed unit DU-2, the UE may send the measurement report related to one or more of the second cells served by the second distributed unit DU-2. That is, the central unit is informed based on the measurement report that the central unit needs to prepare intra-gNB inter-DU L1/L2 mobility towards the second distributed unit DU-2.

In response to receiving the measurement report at step 11, the central unit may determine, at step 12, that the UE is at the border of the first distributed unit DU-1 and the second distributed unit DU-1 and that a handover to the second distributed unit DU-2 may be initiated.

In case the base configuration is specific to the second distributed unit DU-2 (i.e., the base configurations for the first and second distributed units differ from each other), the signaling steps for intra-gNB inter-DU L1/L2 mobility are as follows (step 13 shown in FIG. 16; also referred to as Option 1):

At step 14, the central unit may initiate the handover and send a setup request (e.g., UE Context Setup Request message) to prepare a base configuration to the second distributed unit DU-2. The setup request may include an indication to prepare the base configuration to the second distributed unit DU-2. The setup request may further include cell quality measurements, or measurement results, received from the UE at step 11. That is, the second distributed unit DU-2 is requested by the setup request to prepare the base configuration for intra-gNB inter-DU L1/L2 mobility. In response to the setup request, the second distributed unit DU-2 may prepare the base configuration (i.e., a base template or common part) common to the plurality of second cells served by the second distributed unit DU-2 and a plurality of cell-specific configurations (i.e., a variable part per cell) for the plurality of second cells. For example, the base configuration comprises common configuration parameters of the plurality of second cells. Each of the plurality of cell-specific configurations relates to one of the plurality of second cells. That is, the combination of the base configuration and the cell-specific configuration for a particular cell among the second cells forms the configuration for the particular cell, including the configuration parameters for that particular cell (e.g., configuration parameter necessary for the UE to establish a connection to the particular cell).

At step 15, the second distributed unit DU-2 provides the base configuration and the plurality of cell-specific configurations to the central unit. For example, the second distributed unit DU-2 sends a setup response (e.g., UE Context Setup Response message) to the central unit. The setup response includes the base configuration and the plurality of cell-specific configurations.

At step 16, the central unit sends a handover command (i.e., a Handover Command message) to the UE. The handover command includes the base configuration for the second distributed unit DU-2 and the plurality of cell-specific configurations for the plurality of second cells served by the second distributed unit DU-2. The handover command is to enable execution of the mobility procedure (e.g., intra-gNB inter-DU L1/L2 mobility) by the UE to change from cell 1 to a target cell served by the second distributed unit DU-2.

At step 17, the UE may store the base configuration (i.e., the base template) and the plurality of cell-specific configurations (i.e., the variable part per cell) for the second distributed unit DU-2. For example, the base configuration and the plurality of cell-specific configurations may be stored in the memory of the UE for intra-gNB inter-DU L1/L2 mobility. That is, the UE may store sets of base configuration and cell-specific configurations for different distributed units of the base station gNB1. If the UE already comprises a stored base configuration for the second distributed unit DU-2, which was received previously (e.g., received with a previous reconfiguration message or handover command), the UE may replace at least part of the stored base configuration by the base configuration received at step 16.

At step 18, the UE changes the base configuration and the cell-specific configuration for the target cell using the base configuration for the second distributed unit DU-2 and the cell-specific configuration for the target cell. That is, the UE uses the base configuration for the second distributed unit DU-2 and the cell-specific configuration for the target cell both received from the central unit at step 16 and stored at step 17. In some examples, the UE may combine the base configuration for the second distributed unit DU-2 and the cell-specific configuration for the target cell to form a full configuration for the target cell in the second distributed unit DU-2 and apply the full configuration. In other examples, the UE may first apply the base configuration for the second distributed unit DU-2 and then apply the cell-specific configuration for the target cell. Thereby, the UE replaces at least part of the base configuration for the first distributed unit DU-1 and the cell-specific configuration for the serving cell (i.e., cell 1 of the first distributed unit DU-1). That is, the UE applies the base configuration for the second distributed unit DU-2 and the cell-specific configuration for the target cell served by the second distributed unit DU-2 to switch the UE to the second distributed unit DU-2 and connect the UE to the target cell of the second distributed unit DU-2. The UE may also execute, at step 18, the mobility procedure (i.e., the intra-gNB inter-DU L1/L2 mobility) and performs connection establishment to the target cell of the second distributed unit DU-2. Thereby, the UE switches to the second distributed unit DU-2 and connects to a cell of the second distributed unit DU-2.

In case the base configuration is common to the first distributed unit DU-1 and the second distributed unit DU-2 (i.e., the base configurations for the first and second distributed units do not differ from each other), the signaling steps for intra-gNB inter-DU L1/L2 mobility are as follows (step 19 shown in FIG. 16; also referred to as Option 2):

At step 20, the central unit may initiate the handover and send a setup request (e.g., UE Context Setup Request message) to prepare a base configuration common to the first and second distributed units DU-1 and DU-2. The setup request may include the base configuration for the first distributed unit DU-1. The setup message may further include an indication to prepare the base configuration common to the first and second distributed units DU-1 and DU-2. The setup request may also further include cell quality measurements, or measurement results, received from the UE at step 11. That is, the second distributed unit DU-2 is requested by the setup request to prepare the base configuration for intra-gNB inter-DU L1/L2 mobility. In response to the setup request, the second distributed unit DU-2 may prepare the base configuration (i.e., a base template or common part) for the second distributed unit DU-2 that is common to the base configuration of the first distributed unit DU-1, and a plurality of cell-specific configurations (i.e., a variable part per cell) for the plurality of second cells served by the second distributed unit DU-2. For example, the base configuration comprises common configuration parameters of the base configuration for the first and second distributed units DU-1 and DU-2. Each of the plurality of cell-specific configurations relates to one of the plurality of second cells. That is, the combination of the base configuration common to the first and second distributed units DU-1 and DU-2 and the cell-specific configuration for a particular cell among the second cells forms the configuration for the particular cell, including the configuration parameters for that particular cell (e.g., configuration parameter necessary for the UE to establish a connection to the particular cell).

At step 21, the second distributed unit DU-2 provides the base configuration common for the first and second distributed units DU1 and DU-2 and the plurality of cell-specific configurations to the central unit. For example, the second distributed unit DU-2 sends a setup response (e.g., UE Context Setup Response message) to the central unit. The setup response includes the base configuration and the plurality of cell-specific configurations.

At step 22, the central unit sends a modification request (e.g., UE Context Modification Request message or UE Context Modif Request message) to prepare (or update) a plurality of cell-specific configurations for the plurality of first cells served by the first distributed unit DU-1. The setup request may include the base configuration common to the first and second distributed units DU-1 and DU-2, received at step 21. The modification request may further include an indication to update the plurality of cell-specific configurations. The modification request may further include cell quality measurements, or measurement results, received from the UE at step 11. That is, the first distributed unit DU-1 is requested by the modification request to update the plurality of cell-specific configurations for the plurality of first cells for intra-gNB intra-DU L1/L2 mobility. In response to the modification request, the first distributed unit DU-1 may update the plurality of cell-specific configurations (i.e., a variable part per cell) for the plurality of first cells, using the base configuration common to the first and second distributed units DU-1 and DU-2. For example, the base configuration common to the first and second distributed units DU-1 and DU-2 comprises common configuration parameters of the plurality of first cells. Each of the plurality of cell-specific configurations relates to one of the plurality of first cells. That is, the combination of the base configuration common to the first and second distributed units DU-1 and DU-2 and the cell-specific configuration for a particular cell among the first cells forms the configuration for the particular cell, including the configuration parameters for that particular cell (e.g., configuration parameter necessary for the UE to establish a connection to the particular cell).

At step 23, the first distributed unit DU-1 provides the plurality of cell-specific configurations to the central unit, updated at step 22. For example, the first distributed unit DU-1 sends a modification response (e.g., UE Context Modification Response message or UE Context Modif Response message) to the central unit. The modification response includes the plurality of cell-specific configurations.

At step 24, the central unit sends a handover command (i.e., a Handover Command message) to the UE. The handover command includes the base configuration common to the first and second distributed units DU1 and DU-2 and the plurality of cell-specific configurations for the plurality of first and second cells. The handover command is to enable execution of the mobility procedure (e.g., intra-gNB inter-DU L1/L2 mobility and intra-gNB intra-DU L1/L2 mobility) by the UE to change from cell 1 to a target cell served by the first or the second distributed unit DU-1/DU-2.

At step 25, the UE may store the base configuration (i.e., the base template) and the plurality of cell-specific configurations (i.e., the variable part per cell) for the first and second distributed units DU1 and DU-2. For example, the base configuration and the plurality of cell-specific configurations may be stored in the memory of the UE for intra-gNB inter-DU L1/L2 mobility (and intra-gNB intra-DU L1/L2 mobility). If the UE already comprises a stored base configuration common to the first and second distributed units DU-1 and DU-2, which was received previously (e.g., received with a previous reconfiguration message or handover command), the UE may replace at least part of the stored base configuration by the base configuration received at step 24. The same applies for cell-specific configurations for first and/or second cells stored at the UE.

At step 26, the UE changes the base configuration and the cell-specific configuration for the target cell using the base configuration common to the first and second distributed units DU-1 and DU-2 and the cell-specific configuration for the target cell. That is, the UE uses the base configuration common to the first and second distributed units DU-1 and DU-2 and the cell-specific configuration for the target cell both received from the central unit at step 24 and stored at step 25. In some examples, the UE may combine the base configuration common to the first and second distributed units DU-1 and DU-2 and the cell-specific configuration for the target cell to form a full configuration for the target cell and apply the full configuration. In other examples, the UE may first apply the base configuration common to the first and second distributed units DU-1 and DU-2 and then apply the cell-specific configuration for the target cell. Thereby, the UE replaces at least part of the base configuration common to the first and second distributed units DU-1 and DU-2 and the cell-specific configuration for the serving cell (i.e., cell 1 of the first distributed unit DU-1). That is, the UE applies the base configuration common to the first and second distributed units DU-1 and DU-2 and the cell-specific configuration for the target cell served by the second distributed unit DU-2 to switch the UE to the second distributed unit DU-2 and connect the UE to the target cell of the second distributed unit DU-2. Likewise, the UE may apply the base configuration common to the first and second distributed units DU-1 and DU-2 and the cell-specific configuration for the target cell served by the first distributed unit DU-1 to connect the UE to the target cell of the first distributed unit DU-1. The UE may also execute, at step 26, the mobility procedure (i.e., the intra-gNB inter-DU L1/L2 mobility or intra-gNB intra-DU L1/L2 mobility) and performs connection establishment to the target cell of the first or second distributed unit DU-1/DU-2. Thereby, the UE switches to the second distributed unit DU-2 and connects to a cell of the second distributed unit DU-2, or connects to a cell of the first distributed unit DU-1.

Further details regarding the reconfiguration message received at steps 4 and/or the handover command received at steps 16 and 24 of FIG. 16 will be provided hereinbelow.

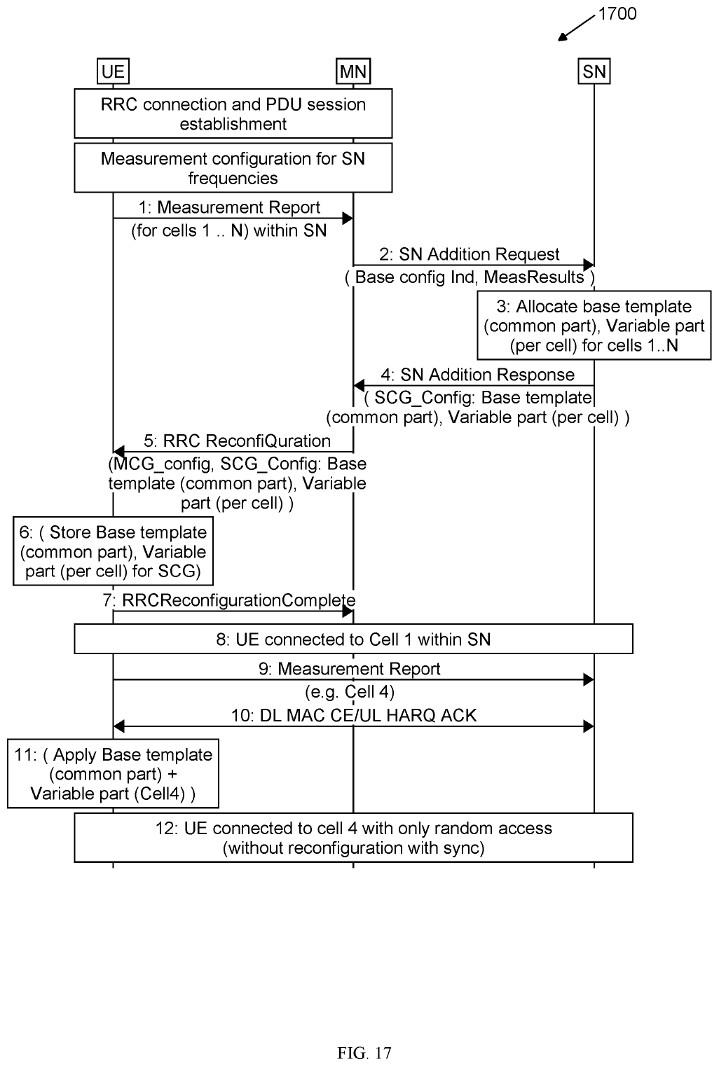

FIG. 17 is an exemplary sequence diagram illustrating MN and SN communication for L1/L2 mobility signalling 1700, according to some example embodiments.

The L1/L2 mobility signalling may be implemented in a dual connectivity setup. In the dual connectivity setup, the UE is connected to both a first network including a master node (MN) and a second network including a secondary node (SN). Each of the nodes MN and SN serves a plurality of cells (referred to as a plurality of first cells served by the master node MN and a plurality of second cells served by the secondary node SN).

According to the general principles of the subject disclosure, during the secondary node SN addition, for preparing L1/L2 mobility in the dual connectivity setup within the secondary node, the master node MN requests the secondary SN to prepare the base configuration and requests preparation for a given set of cells within the secondary node SN. Within the secondary node SN, intra-DU or inter-DU specific preparation as discussed above with reference to FIG. 16 are applied. Similar general principles of the subject disclosure as described above with reference to FIG. 16 apply in view of the UE.

The UE is connected to the master node MN. As it will be understood by one of ordinary skill, the UE is connected to the master node by performing RRC connection procedure and establishing a PDU session. That is, in FIG. 17, the UE is assumed to be RRC connected with PDU session established.

Starting at step 1, the UE may send a measurement report to the master node MN. The measurement report may include measurement results with respect to one or more of the second cells served by the secondary node SN. For example, the UE may be configured by the master node MN for frequencies of the secondary node SN.

At step 2, the master node MN may initiate a handover to the secondary node SN and send an addition request (e.g., SN Addition Request message) to prepare a base configuration to the secondary node SN. The addition request may include an indication to prepare the base configuration for the secondary node SN. The setup request may further include the measurement results, received from the UE at step 1. That is, the secondary node SN is requested by the addition request to prepare the base configuration for L1/L2 mobility. In response to the addition request, the secondary node SN may prepare the base configuration (i.e., a base template or common part) common to the plurality of second cells served by the secondary node SN and a plurality of cell-specific configurations (i.e., a variable part per cell) for the plurality of second cells. For example, the base configuration comprises common configuration parameters of the plurality of second cells. Each of the plurality of cell-specific configurations relates to one of the plurality of second cells. That is, the combination of the base configuration and the cell-specific configuration for a particular cell among the second cells forms the configuration for the particular cell, including the configuration parameters for that particular cell (e.g., configuration parameter necessary for the UE to establish a connection to the particular cell).

At step 3, the secondary node SN allocates the base configuration for the secondary node SN and the plurality of cell-specific configurations for the plurality of second cells.

At step 4, the secondary node SN provides the base configuration and the plurality of cell-specific configurations to the master node MN. For example, the secondary node SN sends an addition response (e.g., SN Addition Response message) to the master node MN. The addition response includes the base configuration and the plurality of cell-specific configurations.

At step 5, the master node MN sends a reconfiguration message (e.g., a RRC Reconfiguration message) to the UE. The reconfiguration message includes the base configuration (e.g., as secondary cell group configuration, SCG_Config) and the plurality of cell-specific configurations received from the secondary node at step 4. The reconfiguration message is to enable execution of the mobility procedure (e.g., L1/L2 mobility) by the UE to change from the serving cell of the master node MN to a target cell served by the secondary node SN. The reconfiguration message may further include MCG_Config information. Further details regarding the reconfiguration message send at step 5 of FIG. 17 will be provided hereinbelow.

At step 6, the UE may store the base configuration (i.e., the base template) and the plurality of cell-specific configurations (i.e., the variable part per cell) for the secondary node SN (i.e., for the SCG). For example, the base configuration and the plurality of cell-specific configurations may be stored in a memory of the UE for L1/L2 mobility. If the UE already comprises a stored base configuration for the secondary node SN, which was received previously (e.g., received with a previous reconfiguration message), the UE may replace at least part of the stored base configuration by the base configuration received at step 5.

At step 7, the UE may acknowledge reception of the reconfiguration message (i.e., the base configuration and the plurality of cell-specific configurations) to the master node MN. For example, the UE may send a reconfiguration complete message (e.g., a RRC Reconfiguration Complete message) to the master node MN. The reconfiguration complete message indicates to the master node MN that the base configuration and the plurality of cell-specific configurations is received and can be used by the UE for L1/L2 mobility.

At step 8, the UE may be connected to a cell (e.g., cell 1) among the plurality of second cells served by the secondary node SN.

At step 9, the UE may send a measurement report to the secondary node SN. The measurement report may be a L1 measurement report related to one or more of the second cells. For example, the UE may report an L1 Reference Signal Received Power (RSRP) measurement to the secondary node SN. In response to receiving the measurement report, the secondary node SN may decide that the UE is to change from the cell (i.e., cell 1) to another cell (e.g., cell 4) served by the secondary node SN. The secondary node SN may initiate the mobility (i.e., the L1/L2 mobility) towards cell 4 as target cell using a Medium Access Control (MAC) Control Element (CE) sent to the UE at step 10. The UE may send, also at step 10, Hybrid Automatic Repeat Request (HARQ) Acknowledgement (ACK) to the secondary node SN in response to the MAC CE. That is, the secondary node SN may send a cell change command to change to the target cell to the UE. The cell change command is to trigger execution of the mobility procedure (i.e., the L1/L2 mobility) to change to the target cell (e.g., cell 4).

At step 11, the UE loads the base configuration for the secondary node SN and applies the cell-specific configuration for the target cell (i.e., cell 4). That is, the UE uses the cell-specific configuration for the target cell received from the master node at step 5 and stored at step 6. In some examples, the UE may combine the base configuration and the cell-specific configuration to form a full configuration for the target cell in the secondary node SN and apply the full configuration. In other examples, the UE may first apply the base configuration for the secondary node SN and then apply the cell-specific configuration for the target cell.

At step 12, the UE executes the mobility procedure (i.e., the L1/L2 mobility) and performs connection establishment to the target cell (i.e., cell 4). For example, the UE may perform only random-access procedure to connect to the target cell. A reconfiguration with synchronization does not need to be performed. Thereby, the UE changes from the serving cell (i.e., cell 1) to the target cell (i.e., cell 4) both served by the secondary node SN.

Examples of the reconfiguration messages shown in FIGS. 15 to 17 will now be described.

The reconfiguration messages may comprise one or more PreparedCellConfig information elements defining a set of parameters to one or more cells (e.g., prepared cells). The PreparedCellConfig information elements may represent the cell-specific configurations for the cells. In other examples, a PreparedCellConfig information element may comprise at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FR1 indicating power to be used in the prepared cell.

That is, in some examples, the reconfiguration messages may comprise one or more PreparedCellConfig information elements defining a set of parameters to a cell group including the serving cell. The PreparedCellConfig information elements may represent the variable part (per cell) configuration. In some examples, the cell group may be comprised of a Media Access Control (MAC) entity, a set of logical channels with associated Radio Link Control (RLC) entities and of a primary cell (SpCell) and one or more secondary cells (SCells). In other examples, the PreparedCellConfig information element may comprise a cellGroupId indicating the cell group, a physCellId identifying the physical cell ID (PCI) of cells, a newUE-Identity used to identify the UE in the cell, a rach-ConfigDedicated indicating random access channel (RACH) parameters to be used in the cell, and a p-NR-FRI indicating power to be used in the cell.

Specifically, the PreparedCellConfig information element(s) is used to patch (i.e., overwrite) a set of parameters to the master cell group (MCG) including the current serving cell. The information element(s) also includes the current serving cell of the UE. For example, in a pool of N cells configured as prepared cells for L1/L2 mobility the current serving cell in which the radio reconfiguration is provided is also included to these N cells.

A PreparedCellConfig information element for a future version of the standard 3GPP TS 38.331 may have the following structure:

PreparedCellConfig information element

-- ASN1START
-- TAG-PREPAREDCELLCONFIG-START
-- Patch the configuration of one Cell-Group:
PreparedCellConfig-v18xy ::= SEQUENCE {

| | |
|---|---|
| cellGroupId-v18xy | CellGroupId, |
| physCellId-v18xy | PhysCellId, |
| newUE-Identity-v18xy | RNTI-Value OPTIONAL, -- Need |

N

| | |
|---|---|
| rach-ConfigDedicated-v18xy | CHOICE { |
| uplink-v18xy | RACH-ConfigDedicated, |
| supplementaryUplink-v18xy | RACH-ConfigDedicated |

} OPTIONAL, -- Need N

| | |
|---|---|
| p-NR-FR1-v18xy | P-Max OPTIONAL, -- Need N |

. . .
}
-- TAG-PREPAREDCELLCONFIG-STOP
-- ASN1STOP

PreparedCellConfig field descriptions

cellGroupId
Always set to 0 for the MCG in the masterCellGroup field.
physCellId
Identifies the PCI of the prepared cell in the spCellConfigCommon field.
newUE-Identity
RNTI to be used in the target cell and if present replaces the existing field in the field
reconfigurationWithSync in the base RRCReconfiguration message
rach-ConfigDedicated
Dedicated RACH parameters to be used in the new cell and if present replaces the existing
field in the field reconfigurationWithSync in the base RRCReconfiguration message
p-NR-FR1
Power to be used in the target cell and if present replaces the field in the field
physicalCellGroupConfig in the base RRCReconfiguration message

The RRC Reconfiguration message is the command to modify an RRC connection. The RRC Reconfiguration message may convey information for measurement configuration, mobility control, radio resource configuration (including RBs, MAC main configuration and physical channel configuration) and AS security configuration.

The RRC Reconfiguration message, e.g. defined by the standard (e.g., 3GPP TS 38.331 V16.7.0 (2021-12) already includes:

### RRCReconfiguration

The RRCReconfiguration message is the command to modify an RRC connection. It may convey information for measurement configuration, mobility control, radio resource configuration (including RBs, MAC main configuration and physical channel configuration) and AS security configuration.

Signalling radio bearer: SRB1 or SRB3

RLC-SAP: AM

Logical channel: DCCH

Direction: Network to UE

RRCReconfiguration message

```
-- ASN1START
-- TAG-RRCRECONFIGURATION-START
RRCReconfiguration ::= SEQUENCE {
  rrc-TransactionIdentifier RRC-TransactionIdentifier,
  criticalExtensions CHOICE {
  rrcReconfiguration RRCReconfiguration-IEs,
  criticalExtensionsFuture SEQUENCE { }
  }
}
RRCReconfiguration-IEs ::= SEQUENCE {
  radioBearerConfig RadioBearerConfig OPTIONAL, -- Need M
  secondaryCellGroup OCTET STRING (CONTAINING CellGroupConfig) OPTIONAL, -- Cond SCG
  measConfig MeasConfig OPTIONAL, -- Need M
  lateNonCriticalExtension OCTET STRING OPTIONAL,
  nonCriticalExtension RRCReconfiguration-v1530-IEs OPTIONAL
}
RRCReconfiguration-v1530-IEs ::= SEQUENCE {
  masterCellGroup OCTET STRING (CONTAINING CellGroupConfig) OPTIONAL, -- Need M
  fullConfig ENUMERATED {true} OPTIONAL, -- Cond FullConfig
  dedicatedNAS-MessageList SEQUENCE (SIZE(1..maxDRB)) OF DedicatedNAS-Message OPTIONAL, -- Cond
nonHO
  masterKeyUpdate MasterKeyUpdate OPTIONAL, -- Cond MasterKeyChange
  dedicatedSIB1-Delivery OCTET STRING (CONTAINING SIB1) OPTIONAL, -- Need N
  dedicatedSystemInformationDelivery OCTET STRING (CONTAINING SystemInformation) OPTIONAL, --
Need N
  otherConfig OtherConfig OPTIONAL, -- Need M
  nonCriticalExtension RRCReconfiguration-v1540-IEs OPTIONAL
}
RRCReconfiguration-v1540-IEs ::= SEQUENCE {
  otherConfig-v1540 OtherConfig-v1540 OPTIONAL, -- Need M
  nonCriticalExtension RRCReconfiguration-v1560-IEs OPTIONAL
}
RRCReconfiguration-v1560-IES ::= SEQUENCE {
  mrdc-SecondaryCellGroupConfig SetupRelease { MRDC-SecondaryCellGroupConfig } OPTIONAL, --
Need M
  radioBearerConfig2 OCTET STRING (CONTAINING RadioBearerConfig) OPTIONAL, -- Need M
  sk-Counter SK-Counter OPTIONAL, -- Need N
  nonCriticalExtension RRCReconfiguration-v1610-IEs OPTIONAL
}
RRCReconfiguration-v1610-IEs ::= SEQUENCE {
  otherConfig-v1610 OtherConfig-v1610 OPTIONAL, -- Need M
  bap-Config-r16 SetupRelease { BAP-Config-r16 } OPTIONAL, -- Need M
  iab-IP-AddressConfigurationList-r16 IAB-IP-AddressConfigurationList-r16 OPTIONAL, -- Need M
  conditionalReconfiguration-r16 ConditionalReconfiguration-r16 OPTIONAL, -- Need M
  daps-SourceRelease-r16 ENUMERATED{true} OPTIONAL, -- Need N
  t316-r16 SetupRelease {T316-r16} OPTIONAL, -- Need M
  needForGapsConfigNR-r16 SetupRelease {NeedForGapsConfigNR-r16} OPTIONAL, -- Need M
  onDemandSIB-Request-r16 SetupRelease { OnDemandSIB-Request-r16 } OPTIONAL, --Need M
  dedicatedPosSysInfoDelivery-r16 OCTET STRING (CONTAINING PosSystemInformation-r16-IEs)
OPTIONAL, -- Need N
  sl-ConfigDedicatedNR-r16 SetupRelease {SL-ConfigDedicatedNR-r16] OPTIONAL, -- Need M
  sl-ConfigDedicatedEUTRA-Info-r16 SetupRelease {SL-ConfigDedicatedEUTRA-Info-r16} OPTIONAL, --
Need M
  targetCellSMTC-SCG-r16 SSB-MTC OPTIONAL, -- Need S
  nonCriticalExtension RRCReconfiguration-v18xy-IEs OPTIONAL
}
MRDC-SecondaryCellGroupConfig ::= SEQUENCE {
  mrdc-ReleaseAndAdd ENUMERATED {true} OPTIONAL, -- Need N
  mrdc-SecondaryCellGroup CHOICE {
  nr-SCG OCTET STRING (CONTAINING RRCReconfiguration),
  eutra-SCG OCTET STRING
  }
}
BAP-Config-r16 ::= SEQUENCE {
  bap-Address-r16 BIT STRING (SIZE (10)) OPTIONAL, -- Need M
  defaultUL-BAP-RoutingID-r16 BAP-RoutingID-r16 OPTIONAL, -- Need M
  defaultUL-BH-RLC-Channel-r16 BH-RLC-ChannelID-r16 OPTIONAL, -- Need M
  flowControlFeedbackType-r16 ENUMERATED {perBH-RLC-Channel, perRoutingID, both} OPTIONAL, --
Need R
  . . .
}
MasterKeyUpdate ::= SEQUENCE {
  keySetChangeIndicator BOOLEAN,
  nextHopChainingCount NextHopChainingCount,
  nas-Container OCTET STRING OPTIONAL, -- Cond securityNASC
  . . .
}
OnDemandSIB-Request-r16 ::= SEQUENCE {
  onDemandSIB-RequestProhibitTimer-r16 ENUMERATED {s0, sodot5, s1, s2, s5, s10, s20, s30}
}
T316-r16 ::= ENUMERATED {ms50, ms100, ms200, ms300, ms400, ms500, ms600, ms1000, ms1500,
ms2000}
IAB-IP-AddressConfigurationList-r16 ::= SEQUENCE {
  iab-IP-AddressToAddModList-r16 SEQUENCE (SIZE(1..maxIAB-IP-Address-r16)) OF IAB-IP-
AddressConfiguration-r16 OPTIONAL, -- Need N
  iab-IP-AddressToReleaseList-r16 SEQUENCE (SIZE(1..maxIAB-IP-Address-r16)) OF IAB-IP-
AddressIndex-r16 OPTIONAL, -- Need N
  . . .
}
IAB-IP-AddressConfiguration-r16 ::= SEQUENCE {
  iab-IP-AddressIndex-r16 IAB-IP-AddressIndex-r16,
  iab-IP-Address-r16 IAB-IP-Address-r16 OPTIONAL, -- Need M
  iab-IP-Usage-r16 IAB-IP-Usage-r16 OPTIONAL, -- Need M
  iab-donor-DU-BAP-Address-r16 BIT STRING (SIZE(10)) OPTIONAL, -- Need M
. . .
}
SL-ConfigDedicatedEUTRA-Info-r16 ::= SEQUENCE {
  sl-ConfigDedicatedEUTRA-r16 OCTET STRING OPTIONAL, -- Need M
  sl-TimeOffsetEUTRA-List-r16 SEQUENCE (SIZE (8)) OF SL-TimeOffsetEUTRA-r16 OPTIONAL -- Need M
}
SL-TimeOffsetEUTRA-r16 ::= ENUMERATED {ms0, ms0dot25, ms0dot5, ms0dot625, ms0dot75, ms1,
ms1dot25, ms1dot5, ms1dot75,
  ms2, ms2dot5, ms3, ms4, ms5, ms6, ms8, ms10, ms20}
-- TAG-RRCRECONFIGURATION-STOP
-- ASN1STOP
```

The RRC Reconfiguration message may in future further include:

```
RRCReconfiguration-v18xy-IEs ::= SEQUENCE {
  PreparedCellConfigList SEQUENCE (SIZE(1..maxPreparedCells)) OF PreparedCellConfig
OPTIONAL, -- Cond N
  nonCriticalExtension SEQUENCE { } OPTIONAL
}
```

For the standard 3GPP TS 38.331, if the UE is configured with PreparedCellConfig: some contents of the stored RRCReconfiguration message may be replaced with PreparedCellConfig; the Random-Access procedure on the SpCell, as specified by TS 38.321 is initiated; and the procedure ends.

The example embodiments of the subject disclose may contribute to avoiding complicated storage and handling of RRC configuration and avoiding applying full configuration (necessity of reconfiguration with sync).

Without the subject disclosure, for each cell, a RRC reconfiguration message and up to N prepared delta configurations and N full configuration messages may result in a total of 2N+1 for N prepared cells in a given distributed unit. The subject disclosure results, in a case where the delta configuration is appended to the base configuration, in one RRC reconfiguration message with the base configuration and N append delta configurations; and, in a case where the delta configuration is replaced to the base configuration, in one RRC reconfiguration message with base configuration and N replace delta configurations.

If the UE moves over all the N cells, N RRC reconfiguration messages and N−1 preparation messages are saved while 2N F1 interface messages to repeat the preparation with the distributed unit for each mobility into each of the N cells. For a modest N of 4, nine RRC containers on the air interface are needed without the subject disclosure, while one only RRC container is needed with the subject disclosure. For CU-DU interface, eight F1 messages are saved whereas only 2 F1 messages are required with the subject disclosure.

Thus, the subject disclosure gains over on both size of RRC message on air interface and number of RRC messages.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst example embodiments have been described in relation to LTE and 5G NR, principles can be adapted and applied in relation to other networks and communication systems where enforcing fast connection re-establishment is required. Therefore, although certain example embodiments were described above by way of example with reference to certain example architectures for wireless networks, technologies and standards, example embodiments may be applied to any other forms of communication systems than those illustrated and described herein.

It is also noted herein that while the above describes example embodiments, there are several variations and modifications which may be made to the disclosed solution without departing from the scope of the subject disclosure.

In general, the various example embodiments may be implemented in hardware or special purpose circuits, software, logic, or any combination thereof. Some aspects of the subject disclosure may be implemented in hardware, while other aspects may be implemented in firmware or software which may be executed by a controller, microprocessor, or other computing device, although the subject disclosure is not limited thereto. While various aspects of the subject disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out example embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks, and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory, and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The following description may provide further details of alternatives, modifications and variances: a gNB comprises e.g. a node providing NR user plane and control plane protocol terminations towards the UE, and connected via the NG interface to the 5GC, e.g. according to 3GPP TS 38.300 V16.6.0 (2021-06) section 3.2 incorporated by reference.

A gNB Central Unit (gNB-CU) comprises e.g. a logical node hosting e.g. RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.401 V16.6.0 (2021-07) section 3.1 incorporated by reference.

Different functional splits between the central and distributed unit are possible, e.g. called options:

### Option 1 (1A-Like Split)

The function split in this option is similar to the 1A architecture in DC. RRC is in the central unit. PDCP, RLC, MAC, physical layer and RF are in the distributed unit.

### Option 2 (3C-Like Split)

The function split in this option is similar to the 3C architecture in DC. RRC and PDCP are in the central unit. RLC, MAC, physical layer and RF are in the distributed unit.

### Option 3 (Intra RLC Split)

Low RLC (partial function of RLC), MAC, physical layer and RF are in the distributed unit. PDCP and high RLC (the other partial function of RLC) are in the central unit.

### Option 4 (RLC-MAC Split)

MAC, physical layer and RF are in the distributed unit. PDCP and RLC are in the central unit.

Or else, e.g. according to 3GPP TR 38.801 V14.0.0 (2017-03) section 11 incorporated by reference.

A gNB supports different protocol layers, e.g.

Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and segm. to segmentation;
Control channels include (BCCH, PCCH).

Layer 3 (L3) includes e.g. Radio Resource Control (RRC), e.g. according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g. be co-located or physically separated. The gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021-06) sections 42.1 and 4.4, incorporated by reference).

A UE is e.g. either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting;

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

Some example embodiments of the subject disclosure may be summarized as follows:

Example 1: An apparatus, comprising: at least one processor; and at least one memory including computer program code; the at least one memory and the computer program code configured to cause the apparatus at least to: receive, from a first network node by a user equipment (UE) connected to a serving cell, a first reconfiguration message including a first base configuration common to a plurality of first cells served by the first network node and a plurality of first cell-specific configurations each related to one of the plurality of first cells to enable execution of a mobility procedure; and apply, by the UE upon execution of the mobility procedure, at least a cell-specific configuration for a first target cell from among the plurality of first cell-specific configurations to connect the UE to the first target cell.

Example 2: The apparatus of example 1, wherein the computer program code is further configured to cause the apparatus at least to: apply, by the UE upon execution of the mobility procedure, the first base configuration and the first cell-specific configuration for the first target cell in response to a base configuration applied for the serving cell being different to the first base configuration.

Example 3: The apparatus of example 1 or 2, wherein the computer program code is further configured to cause the apparatus at least to: store, by the UE, the first base configuration and the plurality of first cell-specific configurations for the first network node.

Example 4: The apparatus of any of examples 1 to 3, wherein the computer program code is further configured to cause the apparatus at least to: send, by the UE to the first network node, a first measurement report including cell quality measurements of the serving cell and one or more of the first cells, wherein the first reconfiguration message is received in response to sending the first measurement report.

Example 5: The apparatus of any of examples 1 to 4, wherein the computer program code is further configured to cause the apparatus at least to: send, by the UE to the first network node, a reconfiguration complete message in response to receiving the first reconfiguration message; send, by the UE to the first network node, a layer 1 (L1) measurement report related to one or more of the first cells to trigger execution of the mobility procedure; and in response to receiving, from the first network node, a cell change command to change to the first target cell, execute, by the UE, the mobility procedure to change from the serving cell to the first target cell.

Example 6: The apparatus of any of examples 1 to 5, wherein the first reconfiguration message comprises one or more PreparedCellConfig information elements defining a set of parameters to one or more first cells, the PreparedCellConfig information elements representing the first cell-specific configurations.

Example 7: The apparatus of any of examples 1 to 6, wherein the computer program code is further configured to cause the apparatus at least to: receive, by the UE from the first network node, a second reconfiguration message including a second base configuration common to a plurality of second cells served by a second network node and a plurality of second cell-specific configurations each related to one of the plurality of second cells to enable execution of the mobility procedure; and apply, by the UE upon execution of the mobility procedure, the second base configuration and a second cell-specific configuration for a second target cell from among the plurality of second cell-specific configurations to connect the UE to the second target cell.

Example 8: The apparatus of example 7, wherein the computer program code is further configured to cause the apparatus at least to: store, by the UE, the second base configuration and the plurality of second cell-specific configurations for the second network node.

Example 9: The apparatus of example 7 or 8, wherein the computer program code is further configured to cause the apparatus at least to: send, by the UE to the first network node, a second measurement report related to one or more of the second cells, wherein the second reconfiguration message is received in response to sending the second measurement report.

Example 10: The apparatus of any of examples 7 to 9, wherein the computer program code is further configured to cause the apparatus at least to: in response to receiving, from the first network node, a handover command to change to the second target cell, execute, by the UE, the mobility procedure to change from the serving cell to the second target cell.

Example 11: The apparatus of any of examples 7 to 10, wherein the second base configuration is further common to the plurality of first cells.

Example 12: The apparatus of any of examples 7 to 11, wherein the second reconfiguration message comprises one or more PreparedCellConfig information elements defining a set of parameters to one or more second cells, the PreparedCellConfig information elements representing the second cell-specific configurations.

Example 13: The apparatus of example 6 or 12, wherein a PreparedCellConfig information element comprises at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FRI indicating power to be used in the prepared cell.

Example 14: The apparatus of example 11 or 12, wherein the computer program code is further configured to cause the apparatus at least to: replace, by the UE, at least part of a stored base configuration received with a previous reconfiguration message based on the set of parameters of the one or more PreparedCellConfig information elements; and initiate, by the UE, a random-access procedure.

Example 15: The apparatus of any of examples 1 to 14, wherein the mobility procedure comprises a layer 1 (L1)/layer 2 (L2) mobility procedure.

Example 16: An apparatus, comprising: at least one processor; and at least one memory including computer program code; the at least one memory and the computer program code configured to cause the apparatus at least to: send, by a first network node to a user equipment (UE) connected to a serving cell, a first reconfiguration message including a first base configuration common to a plurality of first cells served by the first network node and a plurality of first cell-specific configurations each related to one of the plurality of first cells to enable execution of a mobility procedure; and send, by the first network node to the UE, a cell change command to trigger execution of a mobility procedure by the UE to apply at least a cell-specific configuration for a first target cell from among the plurality of first cell-specific configurations to change from the serving cell and connect the UE to the first target cell.

Example 17: The apparatus of example 16, wherein the computer program code is further configured to cause the apparatus at least to: receive, by the first network node from the UE, a first measurement report including cell quality measurements of the serving cell and one or more of the first cells, wherein the first reconfiguration message is sent in response to receiving the first measurement report.

Example 18: The apparatus of example 16 or 17, wherein the computer program code is further configured to cause the apparatus at least to: receive, by the first network node from the UE, a reconfiguration complete message in response to sending the first reconfiguration message; and receive, by the first network node from the UE, a layer 1 (L1) measurement report related to one or more of the first cells to trigger execution of the mobility procedure, wherein the cell change command is sent in response to receiving the L1 measurement report.

Example 19: The apparatus of any of examples 16 to 18, wherein the first reconfiguration message comprises one or more PreparedCellConfig information elements defining a set of parameters to one or more first cells, the PreparedCellConfig information elements representing the first cell-specific configurations.

Example 20: The apparatus of any of examples 16 to 19, wherein the computer program code is further configured to cause the apparatus at least to: send, by the first network node to the UE, a second reconfiguration message including a second base configuration common to a plurality of second cells served by a second network node and a plurality of second cell-specific configurations each related to one of the plurality of second cells to enable execution of the mobility procedure; and send, by the first network node to the UE, a handover command to trigger execution of a mobility procedure by the UE to apply the second base configuration and a second cell-specific configuration for a second target cell from among the plurality of second cell-specific configurations to change from the serving cell and connect the UE to the second target cell.

Example 21: The apparatus of example 20, wherein the computer program code is further configured to cause the apparatus at least to: receive, by the first network node from the UE, a second measurement report related to one or more of the second cells, wherein the second reconfiguration message is sent in response to receiving the second measurement report.

Example 22: The apparatus of example 20 or 21, wherein the second base configuration is further common to the plurality of first cells.

Example 23: The apparatus of any of examples 20 to 22, wherein the computer program code is further configured to cause the apparatus at least to: send, by the first network node to the second network node, a request to prepare the second base configuration and the plurality of second cell-specific configurations; and receive, by the first network node from the second network node, a message including the second base configuration and the second plurality of cell-specific configurations.

Example 24: The apparatus of any of examples 20 to 23, wherein the second reconfiguration message comprises one or more PreparedCellConfig information elements defining a set of parameters to one or more second cells, the PreparedCellConfig information elements representing the second cell-specific configurations.

Example 25: The apparatus of example 19 or 24, wherein a PreparedCellConfig information element comprises at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FRI indicating power to be used in the prepared cell.

Example 26: The apparatus of any of examples 16 to 25, wherein the mobility procedure comprises a layer 1 (L1)/layer 2 (L2) mobility procedure.

Example 27: An apparatus, comprising: at least one processor; and at least one memory including computer program code; the at least one memory and the computer program code configured to cause the apparatus at least to: send, by a first network node to a second network node, a request to prepare a base configuration common to a plurality of cells served by the second network node and a plurality of cell-specific configurations each related to one of the plurality of cells; and receive, by the first network node from the second network node, a message including the base configuration and the plurality of cell-specific configurations.

Example 28: The apparatus of example 27, wherein the computer program code is further configured to cause the apparatus at least to: send, by the first network node to a UE, a reconfiguration message including the base configuration and the plurality of cell-specific configurations; and send, by the first network node to the UE, a handover command to trigger execution of a mobility procedure by the UE to apply the base configuration and a cell-specific configuration for a target cell from among the plurality of cell-specific configurations to connect the UE to the target cell.

Example 29: The apparatus of example 27 or 28, wherein the computer program code is further configured to cause the apparatus at least to: receive, by the first network node from the UE, a measurement report related to one or more of the cells, wherein the request is sent in response to receiving the measurement report.

Example 30: The apparatus of any of examples 27 to 29, wherein the computer program code is further configured to cause the apparatus at least to: use, by the first network node, the base configuration for the second network node to prepare a plurality of cell-specific configurations each related to one of a plurality of cells served by the first network node.

Example 31: An apparatus, comprising: at least one processor; and at least one memory including computer program code; the at least one memory and the computer program code configured to cause the apparatus at least to: receive, by a second network node from a first network node, a request to prepare a base configuration common to a plurality of cells served by the second network node and a plurality of cell-specific configurations each related to one of the plurality of cells; and send, by the second network node to the first network node, a message including the base configuration and the plurality of cell-specific configurations.

Example 32: The apparatus of example 31, wherein the computer program code is further configured to cause the apparatus at least to: allocate, by the second network node, the base configuration, and the plurality of cell-specific configurations for the plurality of cells.

Example 33: A method in a user equipment (UE) connected to a serving cell, comprising: receiving, from a first network node, a first reconfiguration message including a first base configuration common to a plurality of first cells served by the first network node and a plurality of first cell-specific configurations each related to one of the plurality of first cells to enable execution of a mobility procedure; and applying, upon execution of the mobility procedure, at least a cell-specific configuration for a first target cell from among the plurality of first cell-specific configurations to connect the UE to the first target cell.

Example 34: The method of example 33, further comprising: applying, upon execution of the mobility procedure, the first base configuration and the first cell-specific configuration for the first target cell in response to a base configuration applied for the serving cell being different to the first base configuration.

Example 35: The method of example 33 or 34, further comprising: storing the first base configuration and the plurality of first cell-specific configurations for the first network node.

Example 36: The method of any of examples 33 to 35, further comprising: sending, to the first network node, a first measurement report including cell quality measurements of the serving cell and one or more of the first cells, wherein the first reconfiguration message is received in response to sending the first measurement report.

Example 37: The method of any of examples 33 to 36, further comprising: sending, to the first network node, a reconfiguration complete message in response to receiving the first reconfiguration message; sending, to the first network node, a layer 1 (L1) measurement report related to one or more of the first cells to trigger execution of the mobility procedure; and in response to receiving, from the first network node, a cell change command to change to the first target cell, executing the mobility procedure to change from the serving cell to the first target cell.

Example 38: The method of any of examples 33 to 37, wherein the first reconfiguration message comprises one or more PreparedCellConfig information elements defining a set of parameters to one or more first cells, the PreparedCellConfig information elements representing the first cell-specific configurations.

Example 39: The method of any of examples 33 to 38, further comprising: receiving, from the first network node, a second reconfiguration message including a second base configuration common to a plurality of second cells served by a second network node and a plurality of second cell-specific configurations each related to one of the plurality of second cells to enable execution of the mobility procedure; and applying, upon execution of the mobility procedure, the second base configuration and a second cell-specific configuration for a second target cell from among the plurality of second cell-specific configurations to connect the UE to the second target cell.

Example 40: The method of example 39, further comprising: storing the second base configuration and the plurality of second cell-specific configurations for the second network node.

Example 41: The method of example 39 or 40, further comprising: sending, to the first network node, a second measurement report related to one or more of the second cells, wherein the second reconfiguration message is received in response to sending the second measurement report.

Example 42: The method of any of examples 39 to 41, further comprising: in response to receiving, from the first network node, a handover command to change to the second target cell, executing the mobility procedure to change from the serving cell to the second target cell.

Example 43: The method of any of examples 39 to 42, wherein the second base configuration is further common to the plurality of first cells.

Example 44: The method of any of examples 39 to 43, wherein the second reconfiguration message comprises one or more PreparedCellConfig information elements defining a set of parameters to one or more second cells, the PreparedCellConfig information elements representing the second cell-specific configurations.

Example 45: The method of example 38 or 44, wherein a PreparedCellConfig information element comprises at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FRI indicating power to be used in the prepared cell.

Example 46: The method of any of examples 39 to 44, further comprising: replacing at least part of a stored base configuration received with a previous reconfiguration message based on the set of parameters of the one or more PreparedCellConfig information elements; and initiating, by the UE, a random-access procedure.

Example 47: The method of any of examples 33 to 46, wherein the mobility procedure comprises a layer 1 (L1)/layer 2 (L2) mobility procedure.

Example 48: A method in a first network node, comprising: sending, to a user equipment (UE) connected to a serving cell, a first reconfiguration message including a first base configuration common to a plurality of first cells served by the first network node and a plurality of first cell-specific configurations each related to one of the plurality of first cells to enable execution of a mobility procedure; and sending, to the UE, a cell change command to trigger execution of a mobility procedure by the UE to apply at least a cell-specific configuration for a first target cell from among the plurality of first cell-specific configurations to change from the serving cell and connect the UE to the first target cell.

Example 49: The method of example 48, further comprising: receiving, from the UE, a first measurement report including cell quality measurements of the serving cell and one or more of the first cells, wherein the first reconfiguration message is sent in response to receiving the first measurement report.

Example 50: The method of example 48 or 49, further comprising: receiving, from the UE, a reconfiguration complete message in response to sending the first reconfiguration message; and receiving, from the UE, a layer 1 (L1) measurement report related to one or more of the first cells to trigger execution of the mobility procedure, wherein the cell change command is sent in response to receiving the L1 measurement report.

Example 51: The method of any of examples 48 to 50, wherein the first reconfiguration message comprises one or more PreparedCellConfig information elements defining a set of parameters to one or more first cells, the PreparedCellConfig information elements representing the first cell-specific configurations.

Example 52: The method of any of examples 48 to 51, further comprising: sending, to the UE, a second reconfiguration message including a second base configuration common to a plurality of second cells served by a second network node and a plurality of second cell-specific configurations each related to one of the plurality of second cells to enable execution of the mobility procedure; and sending, to the UE, a handover command to trigger execution of a mobility procedure by the UE to apply the second base configuration and a second cell-specific configuration for a second target cell from among the plurality of second cell-specific configurations to change from the serving cell and connect the UE to the second target cell.

Example 53: The method of example 52, further comprising: receiving, from the UE, a second measurement report related to one or more of the second cells, wherein the second reconfiguration message is sent in response to receiving the second measurement report.

Example 54: The method of example 52 or 53, wherein the second base configuration is further common to the plurality of first cells.

Example 55: The method of any of examples 52 to 54, further comprising: sending, by the first network node to the second network node, a request to prepare the second base configuration and the plurality of second cell-specific configurations; and receiving, by the first network node from the second network node, a message including the second base configuration and the second plurality of cell-specific configurations.

Example 56: The method of any of examples 52 to 55, wherein the second reconfiguration message comprises one or more PreparedCellConfig information elements defining a set of parameters to one or more second cells, the PreparedCellConfig information elements representing the second cell-specific configurations.

Example 57: The method of example 51 or 56, wherein a PreparedCellConfig information element comprises at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FRI indicating power to be used in the prepared cell.

Example 58: The method of any of examples 48 to 56, wherein the mobility procedure comprises a layer 1 (L1)/layer 2 (L2) mobility procedure.

Example 59: A method in a first network node, comprising: sending, to a second network node, a request to prepare a base configuration common to a plurality of cells served by the second network node and a plurality of cell-specific configurations each related to one of the plurality of cells; and receiving, from the second network node, a message including the base configuration and the plurality of cell-specific configurations.

Example 60: The method of example 59, further comprising: sending, to a UE, a reconfiguration message including the base configuration and the plurality of cell-specific configurations; and sending, to the UE, a handover command to trigger execution of a mobility procedure by the UE to apply the base configuration and a cell-specific configuration for a target cell from among the plurality of cell-specific configurations to connect the UE to the target cell.

Example 61: The method of example 59 or 60, further comprising: receiving, from the UE, a measurement report related to one or more of the cells, wherein the request is sent in response to receiving the measurement report.

Example 62: The method of any of examples 59 to 61, further comprising: using the base configuration for the second network node to prepare a plurality of cell-specific configurations each related to one of a plurality of cells served by the first network node.

Example 63: A method in a second network node, comprising: receiving, from a first network node, a request to prepare a base configuration common to a plurality of cells served by the second network node and a plurality of cell-specific configurations each related to one of the plurality of cells; and sending, to the first network node, a message including the base configuration and the plurality of cell-specific configurations.

Example 64: The method of example 63, further comprising: allocating the base configuration and the plurality of cell-specific configurations for the plurality of cells.

Example 65: A computer program product comprising program instructions stored on a computer readable medium to execute a method of any of examples 33 to 64 when said program is executed on a computer.

Example 66: An apparatus, comprising: receiving means for receiving, from a first network node by a user equipment (UE) connected to a serving cell, a first reconfiguration message including a first base configuration common to a plurality of first cells served by the first network node and a plurality of first cell-specific configurations each related to one of the plurality of first cells to enable execution of a mobility procedure; and applying means for applying, by the UE upon execution of the mobility procedure, at least a cell-specific configuration for a first target cell from among the plurality of first cell-specific configurations to connect the UE to the first target cell.

Example 67: The apparatus of further comprises implementation means to implement one or more of the examples 2 to 15.

Example 68: An apparatus, comprising: sending means for sending, by a first network node to a user equipment (UE) connected to a serving cell, a first reconfiguration message including a first base configuration common to a plurality of first cells served by the first network node and a plurality of first cell-specific configurations each related to one of the plurality of first cells to enable execution of a mobility procedure; and sending means for sending, by the first network node to the UE, a cell change command to trigger execution of a mobility procedure by the UE to apply at least a cell-specific configuration for a first target cell from among the plurality of first cell-specific configurations to change from the serving cell and connect the UE to the first target cell.

Example 69: The apparatus of further comprises implementation means to implement one or more of the examples 17 to 26.

Example 70: An apparatus, comprising: sending means for sending, by a first network node to a second network node, a request to prepare a base configuration common to a plurality of cells served by the second network node and a plurality of cell-specific configurations each related to one of the plurality of cells; and receiving means for receiving, by the first network node from the second network node, a message including the base configuration and the plurality of cell-specific configurations.

Example 71: The apparatus of further comprises implementation means to implement one or more of the examples 28 to 30.

Example 72: An apparatus, comprising: receiving means for receiving, by a second network node from a first network node, a request to prepare a base configuration common to a plurality of cells served by the second network node and a plurality of cell-specific configurations each related to one of the plurality of cells; and sending means for sending, by the second network node to the first network node, a message including the base configuration and the plurality of cell-specific configurations.

Example 73: The apparatus of further comprises implementation means to implement the example 34.

Example 74: A system comprises a user equipment (UE) with an apparatus according to one or more of the examples 1 to 15, and one or more network nodes with an apparatus according to one or more of the examples 16 to 32.

The various means above serve different functions. A specific means could e.g. be implemented by a specific software module programmed in a way to serve a specific function, e.g. including instructions stored on a memory and when executed by a processor cause an apparatus to perform and/or support a specific function. A specific means could e.g. also be implemented by a specifically configured processor and/or a memory with executable instructions stored thereon. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines.

The foregoing description has provided by way of non-limiting examples a full and informative description of the example embodiments of the subject disclosure. However, various modifications and adaptations may become apparent to those skilled in the relevant arts in view of the foregoing description, when read in conjunction with the accompanying drawings and the claims. However, modifications of the teachings described herein will still fall within the scope of the subject disclosure as defined in the claims. Indeed, there is a further example embodiment comprising a combination of one or more example embodiments with any of the other example embodiments previously discussed.

1-67. (canceled)

68. An apparatus, comprising:
at least one processor; and
at least one memory including computer program code;
the at least one memory and the computer program code configured to cause the apparatus at least to:
receive, from a first network node by a user equipment (UE) connected to a serving cell served by a first distributed unit (DU), a first reconfiguration message including a first base configuration common to a plurality of first cells served by a second distributed unit and a plurality of first cell-specific configurations each related to one of the plurality of first cells to enable execution of an inter-DU mobility procedure; and
apply, by the UE upon execution of the mobility procedure, at least a cell-specific configuration for a first target cell from among the plurality of first cell-specific configurations to connect the UE to the first target cell.

69. The apparatus of claim 68, wherein the computer program code is further configured to cause the apparatus at least to:
apply, by the UE upon execution of the mobility procedure, the first base configuration and the first cell-specific configuration for the first target cell in response to a base configuration applied for the serving cell being different to the first base configuration.

70. The apparatus of claim 68, wherein the computer program code is further configured to cause the apparatus at least to:
store, by the UE, the first base configuration and the plurality of first cell-specific configurations for the first network node.

71. The apparatus of claim 68, wherein the computer program code is further configured to cause the apparatus at least to:
send, by the UE to the first network node, a first measurement report including cell quality measurements of the serving cell and one or more of the first cells, wherein the first reconfiguration message is received in response to sending the first measurement report.

72. The apparatus of claim 68, wherein the computer program code is further configured to cause the apparatus at least to:
send, by the UE to the first network node, a reconfiguration complete message in response to receiving the first reconfiguration message;
send, by the UE to the first network node, a layer 1 (L1) measurement report related to one or more of the first cells to trigger execution of the mobility procedure; and
in response to receiving, from the first network node, a cell change command to change to the first target cell, execute, by the UE, the mobility procedure to change from the serving cell to the first target cell.

73. The apparatus of claim 68, wherein the first reconfiguration message comprises one or more PreparedCellConfig information elements defining a set of parameters to one or more first cells, the PreparedCellConfig information elements representing the first cell-specific configurations.

74. The apparatus of claim 68, wherein the computer program code is further configured to cause the apparatus at least to:
receive, by the UE from the first network node, a second reconfiguration message including a second base configuration common to a plurality of second cells served by a second network node and a plurality of second cell-specific configurations each related to one of the plurality of second cells to enable execution of the mobility procedure; and
apply, by the UE upon execution of the mobility procedure, the second base configuration and a second cell-specific configuration for a second target cell from among the plurality of second cell-specific configurations to connect the UE to the second target cell.

75. The apparatus of claim 74, wherein the computer program code is further configured to cause the apparatus at least to:
store, by the UE, the second base configuration and the plurality of second cell-specific configurations for the second network node.

76. The apparatus of claim 74, wherein the computer program code is further configured to cause the apparatus at least to:
send, by the UE to the first network node, a second measurement report related to one or more of the second cells, wherein the second reconfiguration message is received in response to sending the second measurement report.

77. The apparatus of claim 74, wherein the computer program code is further configured to cause the apparatus at least to:
in response to receiving, from the first network node, a handover command to change to the second target cell, execute, by the UE, the mobility procedure to change from the serving cell to the second target cell.

78. The apparatus of claim 74, wherein the second base configuration is further common to the plurality of first cells.

79. The apparatus of claim 74, wherein the second reconfiguration message comprises one or more PreparedCellConfig information elements defining a set of parameters to one or more second cells, the PreparedCellConfig information elements representing the second cell-specific configurations.

80. The apparatus of claim 73, wherein a PreparedCellConfig information element comprises at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FR1 indicating power to be used in the prepared cell.

81. The apparatus of claim 78, wherein the computer program code is further configured to cause the apparatus at least to:
replace, by the UE, at least part of a stored base configuration received with a previous reconfiguration message based on the set of parameters of the one or more PreparedCellConfig information elements; and
initiate, by the UE, a random-access procedure.

82. The apparatus of claim 68, wherein the mobility procedure comprises a layer 1 (L1)/layer 2 (L2) mobility procedure.

83. An apparatus, comprising:
at least one processor; and
at least one memory including computer program code;
the at least one memory and the computer program code configured to cause the apparatus at least to:
send, by a first network node to a user equipment (UE) connected to a serving cell served by a first distributed unit (DU), a first reconfiguration message including a first base configuration common to a plurality of first cells served by a second distributed unit and a plurality of first cell-specific configurations each related to one of the plurality of first cells to enable execution of an inter-DU mobility procedure; and
send, by the first network node to the UE, a cell change command to trigger execution of a mobility procedure by the UE to apply at least a cell-specific configuration for a first target cell from among the plurality of first cell-specific configurations to change from the serving cell and connect the UE to the first target cell.

84. The apparatus of claim 83, wherein the computer program code is further configured to cause the apparatus at least to:
receive, by the first network node from the UE, a first measurement report including cell quality measurements of the serving cell and one or more of the first cells, wherein the first reconfiguration message is sent in response to receiving the first measurement report.

85. The apparatus of claim 83, wherein the computer program code is further configured to cause the apparatus at least to:
receive, by the first network node from the UE, a reconfiguration complete message in response to sending the first reconfiguration message; and
receive, by the first network node from the UE, a layer 1 (L1) measurement report related to one or more of the first cells to trigger execution of the mobility procedure, wherein the cell change command is sent in response to receiving the L1 measurement report.

86. The apparatus of claim 83, wherein the first reconfiguration message comprises one or more PreparedCellConfig information elements defining a set of parameters to one or more first cells, the PreparedCellConfig information elements representing the first cell-specific configurations.

87. The apparatus of claim 83, wherein the computer program code is further configured to cause the apparatus at least to:
send, by the first network node to the UE, a second reconfiguration message including a second base configuration common to a plurality of second cells served by a second network node and a plurality of second cell-specific configurations each related to one of the plurality of second cells to enable execution of the mobility procedure; and
send, by the first network node to the UE, a handover command to trigger execution of a mobility procedure by the UE to apply the second base configuration and a second cell-specific configuration for a second target cell from among the plurality of second cell-specific configurations to change from the serving cell and connect the UE to the second target cell.

88. The apparatus of claim 86, wherein a PreparedCellConfig information element comprises at least one of: a cellGroupId indicating a cell group, a physCellId identifying the physical cell ID (PCI) of a prepared cell, a newUE-Identity indicating a Radio Network Temporary Identifier (RNTI) to be used to identify the UE in the prepared cell, a rach-ConfigDedicated indicating random access channel (RACH) parameters to be used in the prepared cell, and a p-NR-FR1 indicating power to be used in the prepared cell.

89. The apparatus of claim 83, wherein the mobility procedure comprises a layer 1 (L1)/layer 2 (L2) mobility procedure.

90. An apparatus, comprising:
at least one processor; and
at least one memory including computer program code;
the at least one memory and the computer program code configured to cause the apparatus at least to:
send, by a first network node to a second network node, a request to prepare a base configuration common to a plurality of cells served by the second network node and a plurality of cell-specific configurations each related to one of the plurality of cells; and
receive, by the first network node from the second network node, a message including the base configuration and the plurality of cell-specific configurations.
